(19) United States
(12) Patent Application Publication
(10) Pub. No.: US 2024/0429803 A1
(43) Pub. Date: Dec. 26, 2024

(54) STIMULUS APPLYING DEVICE AND WEARABLE DEVICE

(71) Applicants: Yoshihiro GOMI, Tokyo (JP); Takanori KATO, Tokyo (JP); Yuki TAKAHASHI, Tokyo (JP)

(72) Inventors: Yoshihiro GOMI, Tokyo (JP); Takanori KATO, Tokyo (JP); Yuki TAKAHASHI, Tokyo (JP)

(73) Assignee: MINEBEA MITSUMI Inc., Nagano (JP)

(21) Appl. No.: 18/749,714

(22) Filed: Jun. 21, 2024

(30) Foreign Application Priority Data
Jun. 23, 2023 (JP) 2023-103530

(51) Int. Cl. H02K 33/16; G06F 3/01; H02K 5/04

(52) U.S. Cl. CPC H02K 33/16; G06F 3/016; H02K 5/04

(57) ABSTRACT

A stimulus applying device includes an actuator and a housing. In the actuator, a head part of a protrusion part that protrudes from a movable main body is disposed outside a fixed body, and the movable main body is housed inside the fixed body. The actuator moves the movable main body along the protruding direction of the protrusion part by electromagnetic drive, and applies a stimulus to the surface of a subject by the movement. The housing includes a main surface that extends around the head part in directions intersecting the movement direction. The main surface regulates the position of the subject surface in the movement direction.

### CROSS REFERENCE TO RELATED APPLICATIONS

This application is entitled to or claims the benefit of Japanese Patent Application No. 2023-103530, filed on Jun. 23, 2023, the disclosure of which including the specification, drawings and abstract is incorporated herein by reference in its entirety.

### TECHNICAL FIELD

The present invention relates to a stimulus applying device and a wearable device.

### BACKGROUND ART

Conventionally known are various tactile presentation devices that present a tactile sensation to a user by generating a movement such as a mechanical vibration by using an actuator and transmitting the movement to the user.

For example, as a technology that feeds back the feeling of operation (tactile sensation) on the pad of a user's finger touching a touch panel during the touch operation, a tactile presentation device that gives a vibration to a touch panel by using an actuator is known.

For example, Patent Literature (hereinafter, referred to as PTL) 1 discloses a tactile presentation device including the following: an operation detection part that detects the amount of operation on the operation surface of a panel; an actuator that gives vibration to the operation surface; and a control part that controls the drive of the actuator based on the results of the operation detection part.

The tactile presentation device of PTL 1 is adjusted to impart a tactile sensation with natural intensity; however, depending on the use of the device, it may be desired to impart a more intense tactile sensation, that is, a physical stimulus.

For example, PTL 2 discloses a wearable device in the form of equipment to wear such as a belt or band that can be attached to a subject (body). The wearable device applies a stimuli to the body by externally activating a stimulation module built in the equipment to generate mechanical vibration.

### CITATION LIST

### Patent Literature

### PTL 1

Japanese Patent Application Laid-Open No. 2020-071674

### PTL 2

Japanese Patent Application Laid-Open No. 2019-166327

### SUMMARY OF INVENTION

### Technical Problem

In the case of a device such as the wearable device disclosed in PTL 2 that is used by being attached to a subject, simply attaching the device to the subject imparts a feeling of wearing of the device to the subject over the entire wearing area. Therefore, it is desirable to efficiently transmit the mechanical movement serving as the stimulus from the device to a subject in such a way that the stimulus to be applied to a portion of the wearing area is not diminished by the feeling of wearing of the device.

For example, when the degree of close contact during the attachment of the device to the subject is low, an unnecessary gap is created between the device and the subject, which reduces the intensity of the transmission of the movement from the device to the subject.

On the other hand, when the degree of close contact during the attachment of the device to the subject is high, the movement of the device is reduced due to the occurrence of pushing from the subject to the device, which reduces the intensity of the transmission of the movement from the device to the subject. Changes in the movement transmission intensity that occur depending on the positional relationship between a device and a subject, as in these examples, are undesirable.

For such unwanted changes, it is conceivable to vary the intensity of the movement generated in a device, depending on, for example, the intensity of the feeling of wearing the device. However, increasing the intensity of the movement generated in a device may increase the size of the device.

An object of the present invention is to provide a stimulus applying device and a wearable device each capable of efficiently transmitting a movement to serve as a stimulus to a subject to be stimulated while an increase in device size is limited.

### Solution to Problem

One aspect of a stimulus applying device according to the present invention include:
an actuator and a housing, wherein
the actuator includes a movable main body, a protrusion part that protrudes from the movable main body and includes a head part configured to locally contact with a surface of a subject during use of the stimulus applying device, and a fixed body with a configuration such that the head part is disposed outside the fixed body, and the movable main body is housed inside the fixed body, and the actuator generates a movement of the movable main body in a movement direction along a protruding direction of the protrusion part by electromagnetic drive and locally applies a stimulus to the surface by the movement, and
the housing includes a main surface that extends around the head part in a direction intersecting the movement direction, and the housing allows the main surface to contact with the surface during the use to regulate a position of the surface in the movement direction.

One aspect of a wearable device according to the present invention include:
the stimulus applying device, wherein
the holding part is a belt or clothing that is configured to be attached to the subject during the use.

### Advantageous Effects of Invention

The present invention is capable of efficiently transmitting a movement serving as a stimulus to a subject to be stimulated while an increase in device size is limited.

### BRIEF DESCRIPTION OF DRAWINGS

FIG. 1 is an external perspective view of an actuator included in a stimulus applying device according to an embodiment of the present invention;

FIG. 2 is a longitudinal cross-sectional view illustrating the main part configuration of the actuator;

FIG. 3 illustrates the internal structure of the actuator with the case thereof removed;

FIG. 4 is an exploded perspective view of the actuator;

FIG. 5 is a perspective view of a movable body in the actuator;

FIG. 6 is an enlarged exploded view of the movable body in the actuator;

FIG. 7 is an enlarged partial cross-sectional view of the X1 portion indicating the clearance between the opening and the protrusion part in FIG. 2;

FIG. 8 is an enlarged partial cross-sectional view of the X2 portion indicating the clearance between the outer peripheral surface of the movable body and the inner peripheral surface of the fixed body in FIG. 2;

FIG. 9 is a diagram for explaining the operation of the actuator;

FIG. 10 is a longitudinal cross-sectional view illustrating the main part configuration of variation 1 of the actuator;

FIG. 11 is an enlarged exploded view of a movable body in variation 1 of the actuator;

FIG. 12 is a longitudinal cross-sectional view illustrating the main part configuration of variation 2 of the actuator;

FIG. 13 is an enlarged exploded view of a movable body in variation 2 of the actuator;

FIG. 14 is a longitudinal cross-sectional view illustrating the main part configuration of variation 3 of the actuator;

FIG. 15 is an enlarged exploded view of a movable body in variation 3 of the actuator;

FIG. 16 is a longitudinal cross-sectional view illustrating the main part configuration of variation 4 of the actuator;

FIG. 17 is an enlarged exploded view of a movable body in variation 4 of the actuator;

FIG. 18 is a longitudinal cross-sectional view illustrating the main part configuration of variation 5 of the actuator;

FIG. 19 is a perspective view of a leaf spring in variation 5 of the actuator;

FIG. 20 is a longitudinal cross-sectional view illustrating the main part configuration of variation 6 of the actuator;

FIG. 21 is an enlarged exploded view of a movable body in variation 6 of the actuator;

FIG. 22 is a longitudinal cross-sectional view illustrating the main part configuration of variation 7 of the actuator;

FIG. 23 is an exploded view illustrating the internal configuration of variation 7 of the actuator with the case thereof removed;

FIG. 24 is a longitudinal cross-sectional view illustrating the configuration of a stimulus applying device according to an embodiment of the present invention;

FIG. 25A is a diagram for explaining the problem when the position of a subject surface at an initial position is farther than a proper position is;

FIG. 25B is a diagram for explaining the problem when the position of the subject surface at the initial position is closer than the proper position is;

FIG. 26 is a diagram for explaining the magnitude of reaction force that varies depending on the positional relationship between the subject surface and the protrusion head at the initial position;

FIG. 27A schematically illustrates the overall configuration of a wearable device including the stimulus applying device;

FIG. 27B schematically illustrates a fixed state of a housing in the wearable device;

FIG. 28 illustrates the configuration of a comparative example in which the upper opening of the housing (herein also simply referred to as “housing upper opening”) is wide;

FIG. 29 is a longitudinal cross-sectional view illustrating the configuration of variation 1 of the stimulus applying device;

FIG. 30 is a longitudinal cross-sectional view illustrating the configuration of variation 2 of the stimulus applying device; and

FIG. 31 is a longitudinal cross-sectional view illustrating the configuration of variation 3 of the stimulus applying device.

### DESCRIPTION OF EMBODIMENTS

Hereinafter, embodiments of the present invention will be described in detail with reference to the drawings.

A stimulus applying device according to an embodiment of the present invention includes an actuator that functions as a driving part configured to drive a movable body to generate a movement (mechanical energy). In the following description, first, the configuration and operation of an actuator itself will be described, and then the stimulus applying device and a wearable device according to the present embodiment each including the actuator will be described.

### Overall Configuration of Actuator 1

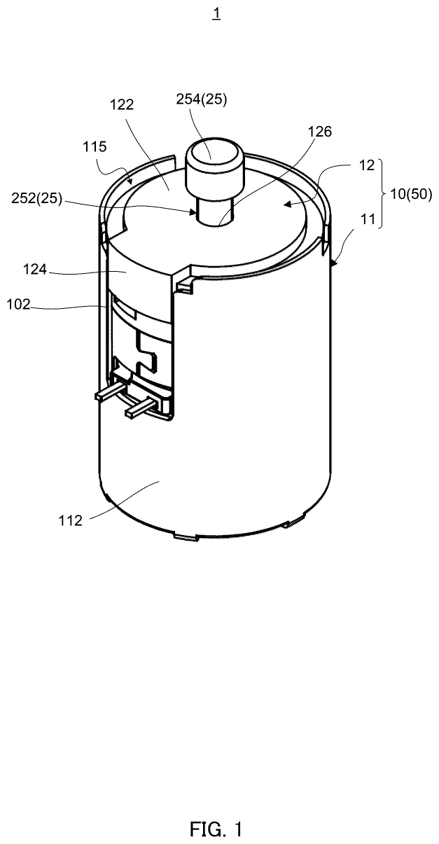

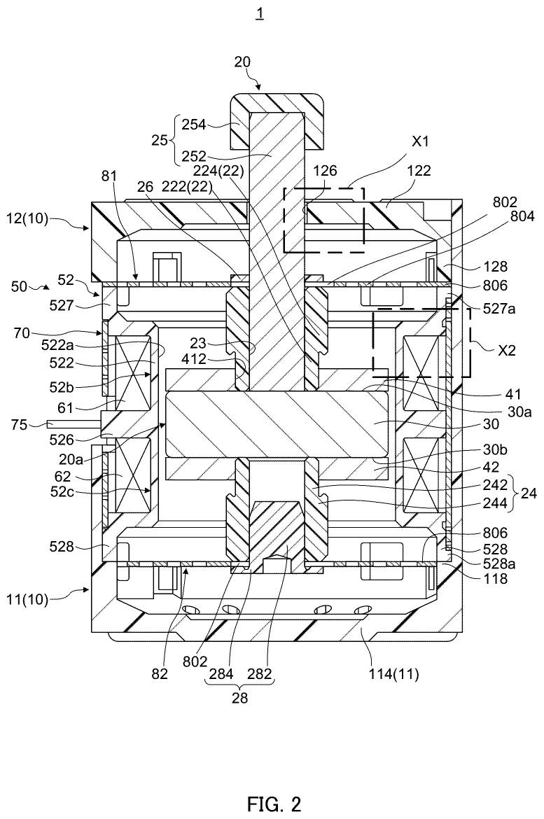

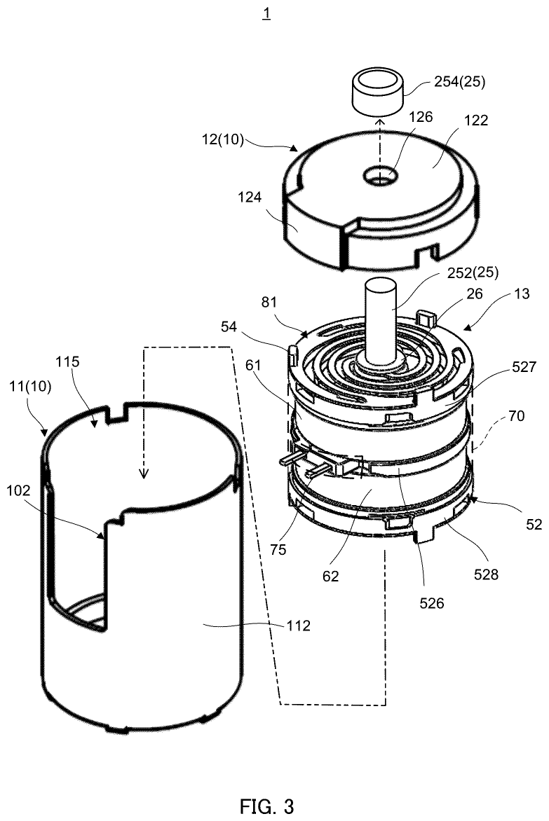

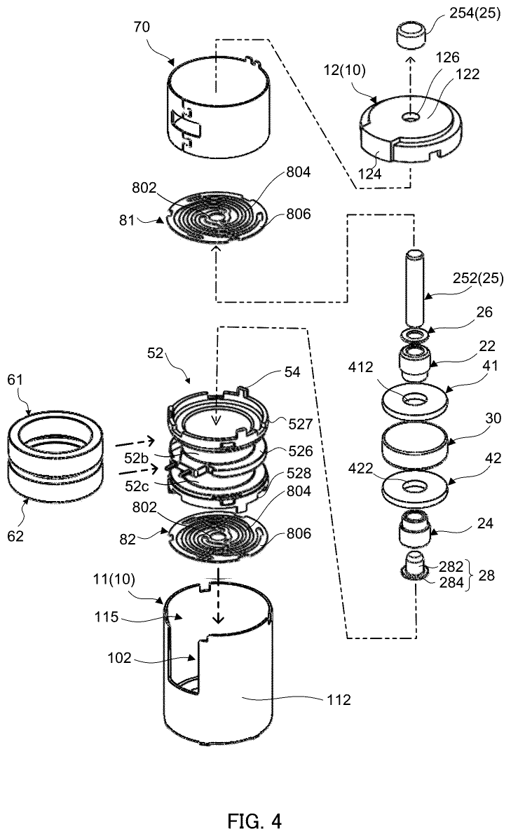

FIG. 1 is an external perspective view of an actuator of an embodiment according to the present invention, and FIG. 2 is a longitudinal cross-sectional view illustrating the main part configuration of the actuator. FIG. 3 illustrates the internal structure of the actuator with the case thereof removed, and FIG. 4 is an exploded perspective view of the actuator. FIG. 3 illustrates components through outer yoke 70 (which is transparent in this drawing) for convenience.

The “upper” side and the “lower” side in the present embodiment are given for convenience to make it easier to understand, and respectively mean one side and the other side in the reciprocating direction of the movable body in the actuator. In other words, when the actuator is installed in the stimulus applying device, top and bottom sides may be reversed and left and right sides may be reversed; however, it is preferable that the direction in which output shaft part 252 (protrusion part 25) protruding from the actuator moves forward and backward is the same as the direction in which the actuator is brought into contact with a stimulation subject. This configuration also applies to each of the variations below.

Actuator 1 according to the present embodiment is used, for example, in haptics including tactile sensation presentation technology, and transmits the reciprocating movement of movable body 20 as a stimulus. Alternatively, actuator 1 may also present a sound to the user so as to appeal to the user's sense of hearing.

Actuator 1 illustrated in FIGS. 1 and 2 includes protrusion part 25 (output shaft part 252) that protrudes from case 10 so as to be movable forward and backward. Protrusion part 25 is a portion of movable body 20 movably housed within case 10. Actuator 1 drives the movable body using a user operation or another condition as a trigger. The movement of the driven movable body is used to apply a stimulus to a subject.

Actuator 1 is preferably used as a device that performs operation detection and tactile feedback in haptics, but the use is not limited thereto. Actuator 1 may be mounted as a vibration generation source in an electronic device such as a portable game terminal device. Actuator 1 may be used simply as a vibration generator, or may be used as a resonance pump, a character input keyboard, an exciter, or the like. Actuator 1 may be used as a vibration presentation device.

Actuator 1 includes output shaft part 252 and magnet 30 in movable body 20, and coils 61 and 62 in fixed body 50. Movable body 20 can reciprocate in a straight line due to the cooperation of the energized coils 61 and 62 and magnet 30. Actuator 1 includes elastic support parts 81 and 82 that support movable body 20 so that the movable body can reciprocate with respect to fixed body 50. As movable body 20 moves forward and backward, output shaft part 252 moves outside the top surface part 122 of case 10 and forward and backward in the axial direction, that is, moves in the axial direction, in the vertical direction in the drawing.

Specifically, actuator 1 includes movable body 20 and fixed body 50—movable body 20 includes a pair of yokes 41 and 42 and a pair of spring retaining parts 22 and 24 in addition to magnet 30, and fixed body 50 includes outer yoke 70 in addition to the pair of annular coils 61 and 62. In addition, a pair of elastic support parts 81 and 82 are provided between movable body 20 and fixed body 50. At least magnet 30 constitutes a movable main body of actuator 1. More specifically, in the present embodiment, the combination of magnet 30, the pair of yokes 41 and 42, and the pair of spring retaining parts 22 and 24 housed in fixed body 50 constitutes the movable main body.

Although yokes 41 and 42, spring retaining parts 22 and 24, and coils 61 and 62 are each provided in pairs of parts, the configuration is not limited thereto, and as long as movability in both directions in a straight line or in one direction can be achieved, each component may be composed of one part or three or more parts.

In actuator 1, coils 61 and 62, outer yoke 70, magnet 30, and yokes 41 and 42 constitute a magnetic circuit that moves movable body 20. In actuator 1, coils 61 and 62 are energized from a power supply part (not illustrated) via terminal part 75 to move movable body 20. Movable body 20 can move forward and backward to both sides of the axial direction (namely the reciprocating direction), or in one direction (namely to one side of the axial direction). Actuator 1 moves, for example, to both sides of the axial direction (see the arrow directions of “upward movable direction” and “downward movable direction” in FIG. 9).

In actuator 1 of the present embodiment, in the inside of coils 61 and 62 held by coil holding part 52, movable body 20 moves forward and backward in the moving direction (which is also the axial direction of coils 61 and 62) along holding part main body (protection wall part) 522 disposed between movable body 20 and the coils. The moving direction is not only the axial direction of coils 61 and 62 but also the magnetizing direction of magnet 30 and the axial direction of coil holding part 52.

As illustrated in FIG. 3, actuator 1 is configured to house unit 13 in case 10 including case main body 11 and lid part 12 In unit 13, fixed body 50 and movable body 20 are connected to each other with elastic support parts 81 and 82. With such a configuration, the main parts of actuator 1 can be assembled with high accuracy in a separate process from case 10.

### Movable Body 20

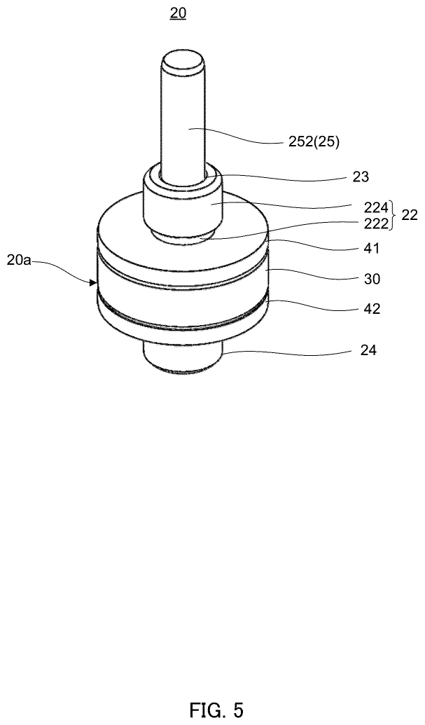

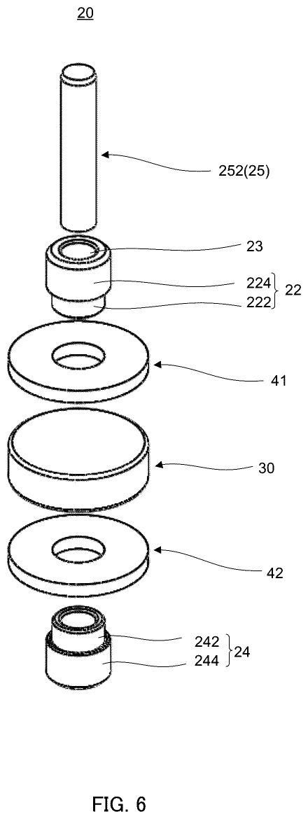

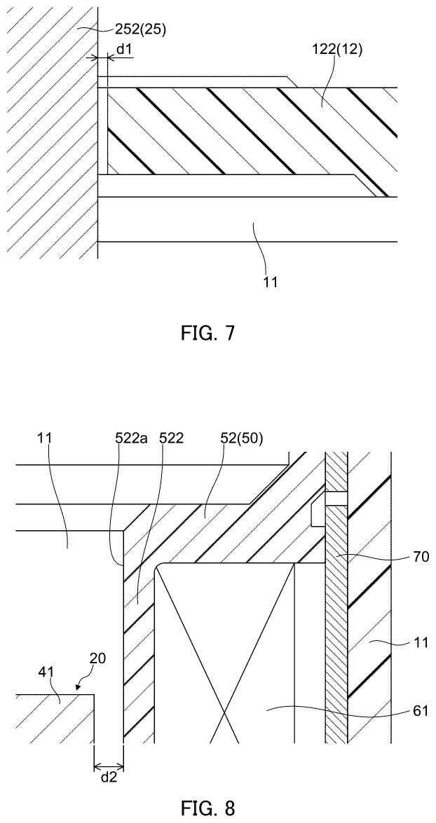

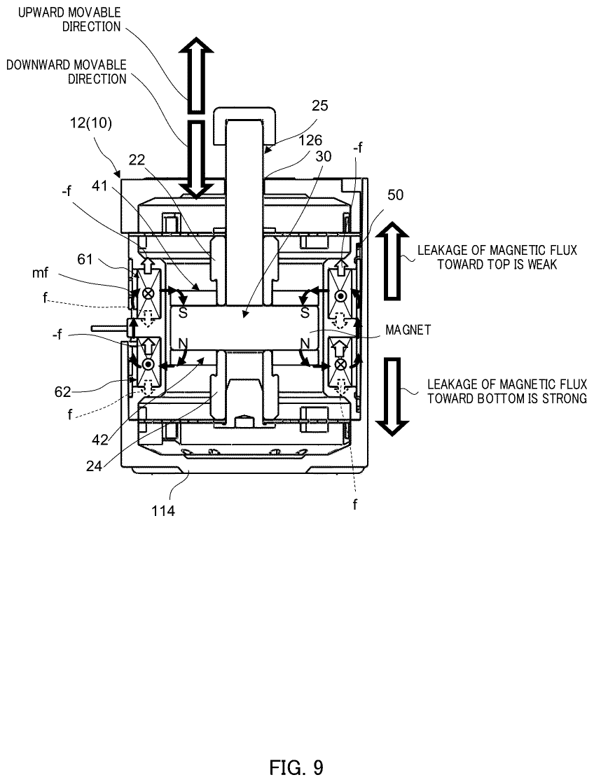

FIG. 5 is a perspective view of the movable body, and FIG. 6 is an enlarged exploded view of the movable body. FIG. 7 is an enlarged partial cross-sectional view of the X1 portion indicating the clearance between the opening and the protrusion part in FIG. 2. FIG. 8 is an enlarged partial cross-sectional view of the X2 portion indicating the clearance between the outer peripheral surface of the movable body and the inner peripheral surface of the fixed body in FIG. 2.

As illustrated in FIG. 2, movable body 20 is disposed with the use of elastic support parts 81 and 82 in such a way that, during a non-moving period, the center of the length of the movable body in the reciprocating direction (which is the axial direction of the magnet and the vertical direction in FIG. 2) is located at the same height level as the center of the length of coil holding part 52 in the reciprocating direction. Herein, the term “non-moving period” (also referred to as no movement period) means a state in which movable body 20 is not moving (including not reciprocating and not vibrating). In addition, being located at the same height level means being located facing each other with a predetermined distance in between in a direction orthogonal to the axial direction of movable body 20.

In the present embodiment, it is preferred that the center of the total length of magnet 30 and yokes 41, 42 in the reciprocating direction is located at a position facing, in a direction orthogonal to the reciprocating direction, the center of the length between coils 61 and 62 separated above and below in the reciprocating direction. A magnetic fluid may be interposed between holding part main body 522 of coil holding part 52 and movable body 20.

As illustrated in FIGS. 2 and 4 to 6, movable body 20 includes output shaft part 252, first spring fixing part 26, and second spring fixing part 28, in addition to magnet 30, yokes 41 and 42, and spring retaining parts (first spring retaining part 22 and second spring retaining part 24).

In movable body 20, yoke (first yoke) 41, yoke (second yoke) 42, first spring retaining part 22, second spring retaining part 24, first spring fixing part 26, and second spring fixing part 28 are provided in series with magnet 30 as the center from the front and back sides of magnet 30 in the axial direction, that is, to both sides of the reciprocating direction.

Specifically, in movable body 20, a pair of yokes 41 and 42 are respectively stacked on the front and back surfaces 30a and 30b of magnet 30, and one ends of the pair of spring retaining parts 22 and 24 are engaged with openings 412 and 422 of the pair of yokes 41 and 42, respectively.

Spring retaining parts 22 and 24 are engaged with elastic support parts 81 and 82 at the other ends of the spring retaining parts, respectively. Output shaft part 252 is provided at first spring retaining part 22 (one of spring retaining parts 22 and 24). Output shaft part 252 protrudes from first spring retaining part 22 to one side of the axial direction of magnet 30 and is inserted through central opening 126 of lid part 12 (see FIGS. 1 to 4 and FIG. 7).

Inside inner peripheral surface 522a of holding part main body 522, outer peripheral surface 20a of magnet 30 and yokes 41 and 42 in movable body 20 faces inner peripheral surface 522a with a predetermined distance between the surfaces (gap d2 illustrated in FIG. 8). When movable body 20 moves forward and backward, outer peripheral surface 20a reciprocates along inner peripheral surface 522a without contacting the inner peripheral surface.

### Magnet 30

Magnet 30 is, for example, solid and magnetized in the reciprocating direction. Magnet 30 is formed in a disk shape, but may have a cylindrical shape with a predetermined thickness. Magnet 30 has front and back surfaces 30a and 30b, which are separated in the reciprocating direction (thickness direction), as magnetic pole surfaces of different polarities (for example, front surface 30a is an S pole and back surface 30b is an N pole).

Magnet 30 is disposed to be spaced apart from coils 61 and 62 (details will be described below) inside coils 61 and 62 in the radial direction. Herein, the “radial direction” is a direction orthogonal to the axes of coils 61 and 62, and also a direction orthogonal to the reciprocating direction. The “distance therebetween (or being spaced apart)” in the radial direction is the distance from coils 61 and 62 including holding part main body 522 to magnet 30, and is a distance that allows movable body 20 to move in the reciprocating direction without contacting each other. That is, in the present embodiment, the term “distance” in this context refers to a predetermined distance (gap d2) between holding part main body 522 and magnet 30.

In the present embodiment, magnet 30 is disposed to face the center of holding part main body 522 in a direction orthogonal to the axial direction, at the center of the width of the outer peripheral surface radially outside. Magnet 30 may have any shape other than a disk shape, such as a tubular shape or a plate shape as long as magnet 30 is disposed inside coils 61 and 62 with its two magnetized surfaces facing away in the direction in which the axes of coils 61 and 62 extend, that is, in the reciprocating direction.

In the present embodiment, magnet 30 is a solid body, and thus unlike the case of a tubular body, there is no need to process the opening, and the area of the front and back surfaces serving as magnetic pole surfaces does not decrease due to the formation of the opening. In addition, it is desirable that the center of magnet 30 in the axial direction coincide with the center of movable body 20 in the axial direction. The magnetization direction of magnet 30 is parallel to the moving direction of movable body 20.

### Yokes 41 and 42

Yokes 41 and 42 are magnetic materials, and together with magnet 30 constitute a movable body side magnetic circuit. Yokes 41 and 42 concentrate the magnetic flux of magnet 30 to flow efficiently without leaking, and effectively distribute the magnetic flux flowing between magnet 30 and coils 61, 62.

In addition, yokes 41 and 42 have a function of fixing spring retaining parts 22 and 24 in addition to functioning as part of the magnetic circuit. Furthermore, in movable body 20, yokes 41 and 42 may have a function as a main body portion of movable body 20 and a function as a weight.

In the present embodiment, yokes 41 and 42 are formed into an annular flat plate shape having the same outer diameter as magnet 30. Yokes 41 and 42 are fixed to magnet 30 so that the outer peripheral surfaces of the yokes are flush with the outer peripheral surface of the magnet, and the outer peripheral surfaces of the yokes constitute outer peripheral surface 20a of movable body 20 together with the outer peripheral surface of the magnet.

Yokes 41 and 42 are members of the same shape that are disposed with magnet 30 located at therebetween, but the yokes may also be members of different shapes. Yokes 41 and 42 are attracted to and fastened to magnet 30, and are also fixed to magnet 30 via, for example, a thermosetting adhesive such as an epoxy resin or an anaerobic adhesive.

Openings 412 and 422 are provided in the central parts of respective yokes 41 and 42 so as to extending through the yokes in the axial direction, that is, in the thickness direction. To openings 412 and 422, one ends of the upper and lower spring retaining parts 22 and 24 are fixed by fitting in the openings, respectively. In addition, at opening 412 (on one side), the base end portion of output shaft part 252 is disposed inside spring retaining part 22. As a result, opening 412 is in a state where substantially no cavity is formed by spring retaining part 22 and output shaft part 252.

In the present embodiment, yokes 41 and 42 are located inside coils 61 and 62 (radially inside) and face respective coils 61 and 62 in a direction orthogonal to the axial direction of coils 61 and 62 when movable body 20 is not reciprocating.

Openings 412 and 422 support spring retaining parts 22 and 24 in such a way that the respective axes of spring retaining parts 22 and 24 (herein, coincident with the centers of elastic support parts 81 and 82) are located on the central axis of movable body 20. Opening 422 can adjust the degree of opening in yoke 42 to adjust the weight of movable body 20, thereby setting a suitable reciprocating movement output. In addition, opening 412 can adjust the degree of opening in yoke 41 and the amount of insertion of output shaft part 252 to adjust the weight of movable body 20, thereby setting a suitable reciprocating movement output.

### Spring Retaining Parts 22 and 24

The pair of spring retaining parts 22 and 24 function as weights of movable body 20. Spring retaining parts 22 and 24 are symmetrically provided with magnet 30 and yokes 41 and 42 located therebetween, and increase the reciprocating movement output of movable body 20. In the present embodiment, spring retaining parts 22 and 24 are formed to have the same shape, thereby reducing the manufacturing cost of the parts. Regarding the details of second spring retaining part 24 of spring retaining parts 22 and 24, the explanation of second spring retaining part 24 is omitted, as first spring retaining part 22 will be mainly explained in the description of first spring retaining part 22, and the corresponding symbols such as spring retaining parts 22 and 24, and the like are used.

In the present embodiment, spring retaining parts 22 and 24 also function as the shaft of the movable body extending along the central axis of movable body 20, and is interposed between yokes 41, 42 and elastic support parts 81, 82.

Spring retaining parts 22 and 24 include joint parts 222 and 242, namely one ends of spring retaining parts 22 and 24, and spring connection parts 224 and 244, namely the other ends of spring retaining parts 22 and 24. These joint parts 222 and 242 are respectively disposed continuous with spring connection parts 224 and 244 in the reciprocating direction.

Spring retaining parts 22 and 24 are tubular bodies and each include through hole 23 extending through the inside thereof. In addition, spring retaining parts 22, 24 may also function as weights. In that case, spring retaining part 24 may have a function of adding a weight into through hole 23 and adjusting the weight balance as a weight adjusting part. By adding a weight into through hole 23 of spring retaining part 24, movable body 20 can be made heavier and the vibration output of movable body 20 can be increased. The base end portion of output shaft part 252 is inserted into through hole 23 of first spring retaining part 22 and is firmly fixed.

Joint parts 222 and 242 are tubular bodies disposed on the axis line of movable body 20, and are joined to yokes 41 and 42, respectively. Joint parts 222 and 242 are joined by inserting one ends thereof into openings 412 and 422 of yokes 41 and 42 and fitting the ends inside the openings, respectively. On the other hand, the other ends of joint parts 222 and 242 are disposed to protrude from yokes 41 and 42 in opposite directions with magnet 30 as the center, and are connected to spring connection parts 224 and 244, respectively.

In the present embodiment, spring retaining parts 22 and 24 are joined to yokes 41 and 42 by press-fitting, but the joining is not limited thereto. The spring retaining parts may be joined by adhesion using, for example, a thermosetting adhesive such as an epoxy resin or an anaerobic adhesive. In addition, joint parts 222 and 242 are tubular bodies in the present embodiment; however, the joint parts may be solid cylinders or rod-shaped bodies including a concave portion on the axis line.

Spring connection part 224 is a tubular body that is provided in spring retaining part 22 so as to protrude from joint part 222 to the one side (upward), and has a larger outer diameter than joint part 222.

Spring connection parts 224 and 244 constitute both ends of movable body 20 that are separated from each other in the moving direction, and are joined to below-described elastic support parts 81 and 82, respectively.

In spring connection part 224, a joint surface (which is a head (upper end) surface thereof) is disposed around output shaft part 252 and comes into contact with the inner peripheral part 802 of elastic support part 81.

### Output Shaft Part 252 (Protrusion Part 25)

Output shaft part 252 is connected to movable body 20, can move together with movable body 20, and outputs the operation of movable body 20 to the outside. Output shaft part 252 is disposed on the axis line of movable body 20. The base end side of the output shaft part is fitted into spring retaining part 22 and directly fixed to movable body 20, and the other end side of the output shaft part is exposed to the outside of actuator 1 through central opening 126 of lid part 12.

Cap 254 is attached to the head of output shaft part 252. Cap 254 constitutes together with output shaft part 252 protrusion part 25; alternatively, output shaft part 252 may be used as protrusion part 25. Cap 254 itself may be contacted by a subject (user), or a separate member may be attached to cap 254 to impart a tactile sensation to the subject via the separate member. Cap 254 may be made of a material different from that of the output shaft part, such as resin or a material that is easily joined to other members. When cap 254 is attached, cap 254 is an example of the head part of the protrusion part 25; when cap 254 is not attached, the head part of output shaft part 252 is an example of the head of the protrusion part 25; and when a separate member is attached to cap 254, the separate member is an example of the head part of protrusion part 25.

Output shaft part 252 is made of a durable material, such as metal, and may be made of either a magnetic material or a non-magnetic material, but is preferably made of a non-magnetic material. When output shaft part 252 is made of a magnetic material, it is desirable to configure the output shaft part not to contact magnet 30.

Output shaft part 252 is a solid cylindrical body, but is not limited to this configuration, and may be hollow. Output shaft part 252 has a circular cross section, but may have any other cross section. The outer shape of the output shaft part 252 (the outer diameter since it is cylindrical) is smaller than the inner diameter of central opening 126 of lid part 12, and has a diameter that allows output shaft part 252 to pass through central opening 126 without contacting.

Output shaft part 252 is disposed together with first spring retaining part 22 in opening 412 of first yoke 41 on magnet 30. With the configuration such that output shaft part 252 is disposed so as to be in contact with magnet 30 through opening 412, by simply inserting output shaft part 252 into through hole 23 of spring retaining part 22 and fitting the output shaft part into opening 412 of yoke 41, these parts can be assembled with each part positioned on the axis.

Output shaft part 252 passes through inner peripheral part 802 (which is the radially inner end (other end) of elastic support part 81 (upper plate spring)), passes through central opening 126 of lid part 12, and protrudes from actuator 1 to the outside. Inner peripheral part 802 of elastic support part 81 is held between the joint surface of spring connection part 224 (namely the head (upper end) surface of spring connection part 224) and first spring fixing part 26 while the inner peripheral part is in contact with the joint surface.

Output shaft part 252 may have any shape as long as output shaft part 252 has a linear shape that extends straight as a whole in the direction in which output shaft part 252 protrudes to the outside of actuator 1.

First spring fixing part 26 is a press-fit ring formed in an annular shape and allows insertion of output shaft part 252 by press-fitting. Inner peripheral part 802 of elastic support part 81 is firmly clamped between spring connection part 224 and first spring fixing part (press-fit ring) 26 and fixed with output shaft part 252 through inner peripheral part 802. An adhesive may be used for this clamping. As a result, spring connection part 224 is in a state of being joined to elastic support part 81.

As described above, in movable body 20, output shaft part 252 is disposed to extend upward from magnet 30 on one direction side (upper side) of the moving direction of movable body 20 and pass through elastic support part 81 and lid part 12. The other end of output shaft part 252 is movable forward and backward outside fixed body 50. With such a configuration, the drive of movable body 20 is directly transmitted to the subject (user) via output shaft part 252, allowing a high speed response and provision of strong feedback.

On the other hand, spring connection part (lower spring connection part) 244 of second spring retaining part 24 is joined to inner peripheral part 802, which is the end of the lower leaf spring (namely elastic support part 82) on the inner diameter side. Here, spring connection part 244 is disposed on the opposite side from spring connection part 224 of first spring stop part 22 with magnet 30 in between.

Spring connection part 244 is a tubular body that is provided in spring retaining part 24 so as to protrude from joint part 242 to the other side (downward), and has a larger outer diameter than joint part 242. Together with second spring fixing part 28 (which is inserted into a through hole of spring connection part 244 that opens at the joint surface), spring connection part 244 holds inner peripheral part 802 of the lower leaf spring (which serves as elastic support part 82) while inner peripheral part 802 is in contact with the joint surface, which is the head (lower end) surface of spring connection part 244.

Specifically, by inserting shaft-shaped insertion part 282 into the through hole of spring connection part 244, second spring fixing part 28 holds inner peripheral part 802 of elastic support part 82 between flange 284 and the joint surface of the spring connection part 244. Flange 284 is provided on the outer periphery of the base end portion of insertion part 282. As a result, spring connection part 244 and elastic support part 82 are joined.

Second spring fixing part 28 may be, for example, a rivet such as a blind rivet. In second spring fixing part 28, the shaft-shaped insertion part 282 is fixed in the through hole of spring connection part 244 by press fitting such as caulking.

In addition, spring retaining parts 22 and 24 may be made of a magnetic material, but are preferably made of a non-magnetic material. When spring retaining parts 22 and 24 are made of non-magnetic material, the magnetic flux from yoke 41 would not flow upward, and the magnetic flux from yoke 42 would not flow downward, so that the magnetic fluxes can efficiently flow to coils 61 and 62 located at the outer peripheral sides of yokes 41 and 42.

Movable body 20 is composed of magnet 30, yokes 41 and 42, spring retaining parts 22 and 24, and output shaft part 252, which are separately configured, and therefore, it is easy to ensure the dimensional accuracy required for each portion. In addition, it is possible to improve the surface accuracy (accuracy of joint surfaces) of spring connection parts 224 and 244 of spring retaining parts 22 and 24, and the dimensional accuracy of the outer diameter of protrusion part 25 (output shaft part 252).

### Elastic Support Parts 81 and 82

Elastic support parts 81 and 82 are disposed on both sides of movable body 20 in the moving direction, and support movable body 20 in a movable manner in the moving direction. Elastic support parts 81 and 82 are plate springs, and are disposed with movable body 20 located therebetween in the vibration direction of movable body 20. Each elastic support part is provided between movable body 20 and fixed body 50 and intersects with the vibration direction.

In detail, elastic support parts 81 and 82 are respectively disposed from both ends

(upper and lower ends) of movable body 20 to the opening edges of fixed body 50 (coil holding part 52). Here, the both ends are separated from each other in the reciprocating direction, and the opening edges are disposed radially outward from the both ends, respectively. In the present embodiment, elastic support parts 81 and 82 are disposed along a direction orthogonal to the reciprocating direction and facing each other with movable body 20 located therebetween in the reciprocating direction.

Elastic support parts 81 and 82 may be made of a non-magnetic material or a magnetic material (specifically, a ferromagnetic material). When elastic support parts are non-magnetic plate springs, stainless steel plates such as SUS304 or SUS316 may be used. In addition, when elastic support parts 81 and 82 are made of magnetic material, stainless steel plates such as SUS301 may be used. As the material for elastic support parts 81 and 82, it is known that a magnetic material (for example, SUS301) is more durable and cheaper than a non-magnetic material (such as SUS304 and SUS316).

Elastic support parts 81 and 82 support movable body 20 in such a way that movable body 20 does not contact fixed body 50 regardless of whether movable body 20 is not reciprocating or is reciprocating. Elastic support parts 81 and 82 may be made of any material as long as they can elastically support movable body 20 in a movable manner.

Elastic support parts 81 and 82 are a plurality of plate-shaped spiral springs that are flat in their normal state. Each of elastic support parts 81 and 82 is configured such that arc-shaped deformable arm parts 804 extend radially outward at equal intervals from the outer edge of annular plate-shaped inner peripheral part 802, and annular plate-shaped outer peripheral fixed part 806 is connected to the ends of the deformable arm parts 804.

Inner peripheral parts 802 has a shape so that the parts are respectively disposed on the joint surfaces of spring connection parts 224 and 244 of spring retaining parts 22 and 24. Inner peripheral parts 802 have, for example, an outer diameter that is approximately the same as the outer diameter of the joint surfaces of spring connection parts 224 and 244.

Deformable arm parts 804 are elastically deformable, and are joined to outer peripheral fixed part 806 at one end and to inner peripheral part 802 at the other end, thereby connecting outer peripheral fixed part 806 with inner peripheral part 802. Deformable arm parts 804 are disposed in a spiral shape between inner peripheral part 802 and outer peripheral fixed part 806 with a predetermined distance in between in the circumferential direction. Movable body 20 may be supported by three or more elastic support parts (plate springs) 81 and 82. These leaf springs are attached along a direction orthogonal to the reciprocating direction.

Inner peripheral parts 802 of elastic support parts 81 and 82 are respectively joined to both ends (spring connection parts 224 and 244) of movable body 20—the both ends are separated in the axial direction (reciprocating direction). In addition, elastic support parts 81 and 82 are disposed such that the outer peripheral fixed part 806 sides protrude radially outward (radial direction) at both ends of movable body 20, respectively.

Outer peripheral fixed part 806 includes a notch formed on the outer peripheral edge thereof, and while the movable range forming part (positioning piece part) 54 of coil holding part 52 is engaged with the notch, outer peripheral fixed parts 806 is held between one of both opening edges of coil holding part 52 and case 10.

Specifically, for elastic support part 81, outer peripheral fixed part 806 is held and fixed between annular upper end surface 527a of flange part 527 and pressing part 128 of lid part 12, within the case 10. Upper end surface 527a means the end surface on the upper side (one side) except movable range forming part 54, on the upper side (one side) of flange part 527.

In addition, for lower elastic support part 82, outer peripheral fixed part 806 is fixed to the lower end of coil holding part 52 on the radially outer side compared to movable body 20 in actuator 1. Specifically, outer peripheral fixed part 806 of elastic support part 82 is fixed to a portion (except movable range forming part 54) in annular lower end surface 528a of lower flange part 528 (which forms the lower end of coil holding part 52).

Elastic support parts 81 and 82 have, for example, the same spiral direction, and in each of which, outer peripheral fixed part 806 (which is one end on the outer peripheral side) is fixed to fixed body 50, and inner peripheral part 802 (which is the other end on the inner peripheral side) is fixed to movable body 20.

As described above, in the present embodiment, a plurality of spiral plate springs are used as elastic support parts 81 and 82 and are attached to both ends (which are separated from each other in the vibration direction) of movable body 20, thereby elastically supporting movable body 20 with respect to fixed body 50. As a result, when the amount of movement of movable body 20 increases, the movable body moves in the translation direction (herein, a direction on a plane perpendicular to the vibration direction) while rotating slightly. When the directions of the spirals of the leaf springs are opposite, the leaf springs would move in the buckling direction or the tensioning direction with respect to each other, and smooth movement would be hindered.

Actuator 1 can move movable body 20, particularly output shaft part 252 (which is protrusion part 25) with enhanced straightness by the pair of elastic support parts 81 and 82.

As a result, the movement of movable body 20 can be performed stably without being affected by external shocks or disturbances. In particular, the stability of straight-line driving can be improved, both the stability of the magnetic sensor output and the stability of the tactile output can be improved.

Elastic support parts 81 and 82 of the present embodiment are fixed to movable body 20 in such a way that the spiral directions of the parts are the same, and therefore, even when the amount of movement of movable body 20 increases, the elastic support parts can move smoothly, that is, can deform, thereby increasing output and increasing the output that becomes force feedback.

However, depending on the desired range of movement of movable body 20, a design may be adopted in which the spiral directions of the plurality of elastic support parts 81 and 82 are opposite to each other.

On the other hand, for upper elastic support part 81, outer peripheral fixed part 806 is fixed to the upper end of coil holding part 52 on the radially outer side. Specifically, outer peripheral fixed part 806 of elastic support part 81 is fixed to a portion (except movable range forming part 54) in annular upper end surface 527a of upper flange part 527 (which forms the upper end of coil holding part 52, see FIG. 2). Details regarding the configuration of coil holding part 52 will be described later.

Outer peripheral fixed part 806 of elastic support part 82 is held and fixed within the case 10 between annular lower end surface 528a of flange part 527 and stepped part 118 provided at the peripheral edge of bottom part 114. Lower end surface 528a means the end surface on the lower side (the other side) in flange part 527 on the lower side (the other side), except movable range forming part 54.

Outer peripheral fixed part 806 is formed in an annular shape, and its outer peripheral portion is held between upper or lower end surface 527a, 528a (see FIG. 2) of coil holding part 52 and pressing part 128 or stepped part 118. Outer peripheral fixed parts 806 are thus fixed to fixed body 50.

### Fixed Body 50

As illustrated in FIG. 2, fixed body 50 holds coils 61 and 62 and also supports movable body 20 inside the coils 61 and 62 in the radial direction in such a way that movable body 20 is movable in the moving direction (the axial direction of the magnet, the coil axial direction, or axial direction of the movable body 20) through elastic support parts 81 and 82.

Fixed body 50 includes coil holding part 52 that holds coils 61 and 62, in addition to coils 61 and 62 and outer yoke 70.

Actuator 1 is configured in such a way that in addition to coils 61 and 62, substantially all of the components that generate vibrations, such as movable body 20 through elastic support parts 81 and 82 and case 10, are connected to coil holding part 52.

Coil holding part 52 is a tubular body, holds coils 61 and 62 disposed on the outer peripheral surface thereof, and surrounds magnet 30 with inner peripheral surface 522a. In coil holding part 52, movable body 20 including magnet 30 is movably disposed. Coil holding part 52 may be formed in a bobbin shape, and in this case, coils 61 and 62 are disposed so as to be wound around the outer periphery of the inner tubular holding part main body (protective wall) in coil holding part 52.

Coil holding part 52 is a tubular body made of resin such as phenol resin and polybutylene terephthalate (PBT). In the present embodiment, coil holding part 52 is made of a material containing a highly flame-retardant phenolic resin such as Bakelite.

Coil holding part 52 is made of a material containing phenolic resin to increase flame retardancy, and therefore, even when heat is generated due to Joule heat with current flowing through coils 61 and 62 held in the coil holding part, safety during driving can be improved. In addition, the dimensional accuracy is increased to increase the positional accuracy of coils 61 and 62, and therefore, variations in vibration characteristics can be reduced.

Specifically, coil holding part 52 includes the following: tubular holding part main body 522; central flange part 526 protruding in the radial direction from the outer periphery of holding part main body 522; flange parts 527 and 528; terminal part 75; and movable range forming part 54.

Holding part main body 522 functions as a protective wall part that protects coils 61 and 62 from colliding with movable body 20 disposed inside when movable body 20 is driven. The thickness of holding part main body 522 is set to give strength such that even when moving movable body 20 comes into contact with the holding part main body, such contact does not affect coils 61 and 62 on the outer peripheral side at all.

On the outer peripheral side of holding part main body 522, coils 61 and 62 are disposed side by side in the coil axial direction between central flange part 526 and respective flange parts 527 and 528 (coil attachment parts 52b and 52c). Holding part main body 522 has a configuration such that coils 61 and 62 are positioned so as to surround the radially outside of the outer peripheral surfaces of yokes 41 and 42 of movable body 20 (the outer peripheral surfaces of magnet 30 and yokes 41 and 42).

Specifically, holding part main body 522 include, in the outer peripheral surface thereof, concave coil attachment parts 52b and 52c that are partitioned by central flange part 526 and flange parts 527 and 528, and open radially outward on the outer peripheral side.

Terminal parts 75 allow the coil windings of coils 61 and 62 to wrap around and function as connector connecting parts for connecting the coil windings to an external device. Coils 61 and 62 are connected to the external device via terminal parts 75, and power can be supplied to coils 61 and 62 from the external device.

Terminal part 75 is a conductive member that protrudes from the outer peripheral portion of holding part main body 522. In the present embodiment, terminal part 75 is press-fitted into the outer peripheral surface of central flange part 526 disposed at the center in the vibration direction on the outer periphery of holding part main body 522. Terminal part 75 is thus provided so as to protrude from the outer peripheral surface of central flange part 526.

Flange parts 527 and 528 are respectively provided at both ends of holding part main body 522 that are separated from each other in the axial direction (that is the vibration direction and the vertical direction in the present embodiment). Flange parts 527 and 528 constitute upper and lower ends of coil holding part 52.

Flange parts 527 and 528 are located at the ends in the directions away from central flange part 526 (upper and lower ends in the present embodiment). Elastic support parts 81 and 82 are fixed to flange parts 527 and 528.

Movable range forming parts 54 are projection-shaped parts provided at the upper and lower ends of coil holding part 52 to protrude in the axial direction. Movable range forming part 54 forms a vibration range between lid part 12 or bottom part 114 of case 10 and movable body 20 when coil holding part 52 is housed in case 10. Movable range forming parts 54 are provided with a predetermined distance in between on annular upper and lower end surfaces (also referred to as “upper and lower end surfaces,” or “open end surfaces”) 527a and 528a of flange parts 527 and 528. Upper end surface 527a is an open end surface on one side, and lower end surface 528a is an open end surface on the other side.

Movable range forming parts 54 fit into notches provided in elastic support parts 81 and 82 to position elastic support parts 81 and 82 in the radial direction. By fitting movable range forming parts 54 into the notches, in each individual unit 13, the attaching positions of elastic support parts 81 and 82 can be set uniformly with respect to coil holding part 52, and stable positioning of elastic support parts 81 and 82 with respect to coil holding part 52 can be performed. In addition, elastic support parts 81 and 82 are not fixed to the fixed body side with respect to coil holding part 52 via a plurality of components. As a result, the structure is not easily affected by component tolerances, and rotational movement in the circumferential direction and radial direction is restricted, and as a product, variations in elastic support parts 81 and 82 can be reduced, thereby achieving stable characteristics.

Coil holding part 52 is housed in case 10 with movable range forming parts 54 on the upper and lower end surfaces in contact with the edge of lid part 12 and the edge of bottom part 114, and is fixed to the edge of lid part 12 and the edge of bottom part 114.

### Coil

In actuator 1, coils 61 and 62 are used to generate a driving source for actuator 1 together with magnet 30 and yokes 41 and 42, with the axial direction of coils 61 and 62 (the magnetization direction of magnet 30) as the vibration direction.

Coils 61 and 62 generate a magnetic field when energized to move movable body 20. Coils 61 and 62 are disposed on the outside of movable body 20 in the radial direction. Coils 61 and 62 together with magnet 30 constitute a magnetic circuit similar to a voice coil motor.

Coils 61 and 62 are disposed in coil attachment parts 52b and 52c. In the present embodiment, coils 61 and 62 are disposed at positions facing yokes 41 and 42 in a direction orthogonal to the reciprocating direction.

Coils 61 and 62 are held by coil holding part 52 in such a way that the center position of the length from one end of one coil to the other end of the other coil in the coil axial direction (reciprocating direction) is approximately the same position (including the same position) in the reciprocating direction as the center position of the length of movable body 20 in the reciprocating direction (the center position of magnet 30 in the reciprocating direction). Coils 61 and 62 of the present embodiment are wound in opposite directions, and are configured so that current flows in opposite directions when energized. Coils 61 and 62 are fixed within the concave coil attachment parts 52b and 52c by an adhesive or the like. Inside case 10, the outer peripheral surfaces of the coils are surrounded by outer yoke 70.

The ends of coils 61 and 62 wrap around terminal parts 75 of central flange part 526 to be connected. Coils 61 and 62 are connected to an external power supply part via terminal parts 75. For example, the following configuration is possible: each end of coils 61 and 62 is connected to a DC supply part, and coils 61 and 62 are supplied with DC power from the DC supply part. Coils 61 and 62 can thus generate a thrust force between the coils and the magnet that allows them to move toward or away from each other in the axial directions of the coils and the magnet.

The following configuration is also possible: the respective ends of coils 61 and 62 are connected to power supply parts such as an AC supply part and a DC supply part, and AC power (AC voltage) and DC power (DC voltage) are supplied from the power supply parts to coils 61 and 62. Coils 61 and 62 can thus generate thrust forces between the coils and the magnet that allows them to move toward and away from each other in the axial directions of the coils and the magnet.

The power supplied to coils 61 and 62 may be either AC current or DC current, and the thrust of movable body 20 is generated in accordance with each power supply. In addition, a configuration in which both AC and DC are supplied to coils 61 and 62 is naturally possible. Actuator 1 may move movable body 20 by superimposing AC current on input DC current. For example, actuator 1 first pushes out or lowers movable body 20, that is, protrusion part 25, by using the input DC current. Thereafter, actuator 1 can superimpose the input AC or pulse on the input DC current in response to some trigger, thereby imparting a tactile sensation such as force feedback. Furthermore, at least one of the DC supply part and the AC supply part connected to ends of coils 61 and 62 may be provided in the actuator itself.

### Outer Yoke 70

Outer yoke 70 is a tubular magnetic body that surrounds the outer peripheral surface of coil holding part 52 and is disposed at a position to cover coils 61 and 62 on the outside in the radial direction. Outer yoke 70 prevents leakage of the magnetic flux from actuator 1 to the outside in the radial direction in the magnetic circuit.

Outer yoke 70 is disposed in such a way that the center of the length of outer yoke 70 in the reciprocating direction is at the same height as the center of magnet 30 (disposed in the inside of the outer yoke) in reciprocating direction. Due to the shielding effect of outer yoke 70, leakage of the magnetic flux to the outside of the actuator can be reduced.

In addition, outer yoke 70 can increase the thrust constant and improve the electromagnetic conversion efficiency in the magnetic circuit. Outer yoke 70 utilizes the magnetic attraction force of magnet 30 to function as a magnetic spring together with magnet 30. The magnetic spring can reduce stress when elastic support parts 81 and 82 are mechanical springs, and can improve the durability of elastic support parts 81 and 82.

### Case 10

Case 10 houses movable body 20 and coils 61 and 62 with the protruding end side of protrusion part 25 protruding to the outside. Case 10 houses movable body 20 together with coils 61 and 62, and includes central opening 126 into which protrusion part 25 is loosely inserted without contact.

Specifically, case 10 includes bottomed tubular case main body 11 that includes peripheral wall part 112 and bottom part 114, and lid part 12 that closes opening 115 of case main body 11. The case 10 is columnar. Being columnar is having a height (thickness) that can generate sufficient thrust in the reciprocating direction by cooperation with coils 61 and 62 facing the case on the outer periphery. For example, case 10 of the present embodiment is formed to have a cylindrical shape by the bottomed tubular case main body 11 and lid part 12, but the shape is not limited thereto and may be an elliptical cylinder or a polygonal columnar. The elliptical cylinder or elliptical shape in the elliptical cylinder in the present embodiment is an ellipse that mainly includes parallel linear portions, and means an oval shape.

Lid part 12 and bottom part 114 constitute top surface part 122 and bottom surface part (bottom part 114) of actuator 1 in the present embodiment. Lid part 12 and bottom part 114 are disposed to face movable body 20 of unit 13 with predetermined distances in between in the reciprocating direction of movable body 20.

Lid part 12 includes projection part 124 on top surface part 122 including central opening 126. Projection part 124 projects radially outward from a portion of the outer periphery of top surface part 122 and engages with notch part 102 of case main body 11. Projection part 124 allows lid part 12 to engage with notch part 102 of case main body 11, thereby positioning lid part 12 during the attachment of the lid part to case main body 11. Lid part 12 and bottom part 114 each have a function as a movable range suppressing part that serves as a hard stop (limiting the movable range) of movable body 20.

The opening direction of central opening 126 is parallel to the moving direction of movable body 20 and output shaft part 252, and specifically, central opening 126 is preferably formed so that output shaft part 252 is inserted vertically.

Central opening 126 is formed in top surface part 122 on the axis lines of movable body 20 and output shaft part 252 and has a diameter larger than the outer diameter of output shaft part 252.

As illustrated in FIG. 7, central opening 126 is formed in top surface part 122 in such a way that gap d1 is provided between output shaft part 252 to be inserted and central opening 126 so that output shaft part 252 to be inserted does not come into contact with central opening 126 during a non-moving period and during a moving period.

Central opening 126 is formed in top surface part 122 in such a way that gap d1 between the outer diameter of output shaft part 252 and the inner diameter of central opening 126 is smaller than gap d2 illustrated in FIG. 8 between outer peripheral surface 20a of movable body 20 and the inner peripheral surface (inner peripheral surface 522a of holding part main body 522) of fixed body 50.

When lid part 12 is attached to case main body 11, projection part 124 of lid part 12 is disposed in notch part 102 of case main body 11 above terminal parts 75 that are exposed to the outside and located at the central part of notch part 102 in the longitudinal direction. The positions of the terminal parts 75 of actuator 1 thus can be determined simply by viewing lid part 12 from above.

### Operation of Actuator 1

The operation of actuator 1 will be explained using FIG. 9 with an exemplary case in which the front surface 30a side of magnet 30 on one side in the magnetization direction (the upper side in the present embodiment) is the S pole, and the back surface 30b side of magnet 30 on the other side in the magnetization direction (the lower side in the present embodiment) is the N pole.

FIG. 9 is a diagram for explaining the operation of an actuator of Embodiment 1 according to the present invention.

In actuator 1, pulse currents (DC pulse or AC pulse) are supplied to coils 61 and 62 to drive movable body 20 to move in at least to one side of the vibration direction. Power may be supplied to coils 61 and 62 so that they resonate.

By supplying a pulse current, magnetic flux flow mf is formed such that the magnetic flux is emitted from the back surface 30b side of magnet 30, radiated from yoke 42 to the coil 62 side, passes through outer yoke 70, and enters magnet 30 from yoke 41 on the upper side of magnet 30 via coil 61.

Therefore, when energization is performed as illustrated in FIG. 9, Lorentz force in the −f direction is generated in coils 61 and 62 according to Fleming's left-hand rule due to the interaction between the magnetic field of magnet 30 and the current flowing in coils 61 and 62.

The Lorentz force in the −f direction is orthogonal to the direction of the magnetic field and the direction of the current flowing through coils 61 and 62. Coils 61 and 62 are fixed to fixed body 50 (coil holding part 52), and therefore, according to the law of action and reaction, a force opposite to the Lorentz force (in the −f direction) is applied to movable body 20 including magnet 30 as thrust in the f direction. Movable body 20 with magnet 30 moves in the f direction, that is, toward the bottom part (the bottom surface of case main body 11) 114 side.

On the other hand, when the energization direction of coils 61 and 62 is switched to the opposite direction and coils 61 and 62 are energized, Lorentz force in the opposite f direction is generated. Due to the generation of this Lorentz force in the f direction, a force opposite to the Lorentz force (in the f direction) is applied to movable body 20 as a thrust (a thrust in the −f direction), and movable body 20 moves in the −f direction, that is, to the top surface side of lid part 12 of fixed body 50.

In actuator 1, by moving movable body 20 only to either the lid part 12 side or the bottom part 114 side, feedback such as tactile or force feedback can be provided to a subject via output shaft part 252. For applying a stimulus, it is preferable to move movable body 20 toward lid part 12.

At this time, output shaft part 252 passes through central opening 126 of case 10 without contacting central opening 126, and moves in the moving direction (axis of magnet 30, forward/backward direction) outside case 10 without contacting central opening 126.

In addition, it is also possible to cause the movement by alternately supplying currents to coils 61 and 62 in opposite directions, and with such a configuration, thereby performing tactile and force feedback by the movement of movable body 20.

In addition, during no energization in actuator 1 so that no drive is occurred (non-moving period), magnetic attraction forces act between magnet 30 and outer yoke 70, and function as magnetic springs. Movable body 20 returns to its original position due to the magnetic attraction forces generated between magnet 30 and outer yoke 70 and the restoring force of elastic support parts 81 and 82 to return to their original shapes.

Actuator 1 includes fixed body 50 including coils 61 and 62, and movable body 20 including magnet 30 that is disposed radially inside coils 61 and 62 and magnetized in the axial direction of coils 61 and 62. Actuator 1 also includes flat plate shaped elastic support parts 81 and 82, which elastically hold movable body 20 in a movable manner in the moving direction (which is the coil axis direction).

In addition, coils 61 and 62 are disposed on the outer periphery of holding part main body 522 of coil holding part 52; outer peripheral surface 20a of movable body 20 is disposed on the inner peripheral side of holding part main body 522 with a predetermined distance in between; and outer peripheral surfaces of coils 61 and 62 are surrounded by outer yoke 70.

Actuator 1 has a structure in which unit 13 is housed within case 10, and the outer peripheral surface of the peripheral wall part 112 of case 10 made of resin can be configured to be a smooth surface. For attaching actuator 1 to an electronic device, it is thus possible to reliably and easily attach a cushioning material such as a sponge to be interposed between actuator 1 and an attachment location.

In addition, actuator 1 is formed by disposing unit 13 within case 10, and therefore, elastic support parts 81 and 82, which require high dimensional accuracy, can be fixed by being assembled to coil holding part 52.

The disposing of movable body 20 (including the fixing of elastic support parts 81 and 82) thus can be determined by using coil holding part 52 as a reference, and the accuracy of the direction in which the tactile sensation is generated as a product can be improved. Specifically, by increasing the dimensional accuracy of coil holding part 52 (which is formed as a single component from, for example, resin), coils 61 and 62 and movable body 20 (magnet 30) to be attached through elastic support parts 81 and 82 can be easily positioned in an accurate positional relationship.

In addition, terminal parts 75 are provided on coil holding part 52 so as to protrude outward, and therefore, the coil wires of the coils can easily wrap around terminal parts 75 and soldered, thereby facilitating the connection between external devices and coils 61 and 62.

As described above, actuator 1 has impact resistance and can provide a tactile sensation.

Actuator 1 is driven by pulses (DC pulses or AC pulses) input to coils 61 and 62. That is, the following is possible: by properly setting the energization directions of coils 61 and 62, a thrust in the f direction to the top surface part 122 side of lid part 12, or a thrust force in the f direction to the bottom part 114 side is applied to movable body 20, or thrust forces in the −f direction and the f direction are applied alternately to movable body 20. Movable body 20 thus can move in the moving direction, and by moving in the moving direction, movable body 20 can provide tactile feedback via actuator 1 itself or output shaft part 252.

As described above, actuator 1 can be produced easily at low cost and has a detection function and a tactile feedback function that are easier to use.

### Driving Principle of Actuator 1

The driving principle of actuator 1 will be briefly described. For example, actuator 1 is driven by a supplied pulse in one direction (here, the same as the axial direction of the magnet, vibration direction, or vertical direction) based on the following equation of motion (1) and circuit equation (2). In the present embodiment, actuator 1 is driven by the input of short pulses; however, actuator 1 may be driven to generate arbitrary reciprocating movement or vibration without using short pulses.

Movable body 20 in actuator 1 moves forward and backward based on equations (1) and (2).

$$m \frac{{d}^{2} x ( t )}{{dt}^{2}} = {K}_{f} i ( t ) - {K}_{ap} x ( t ) - D \frac{dx ( t )}{dt} \qquad Equation 1$$

m: mass [Kg]
x(t): displacement [m]
K_{f}: thrust constant [N/A]
i(t): current [A]
Kₛₚ: spring constant [N/m]
D: attenuation coefficient [N/(m/s)]

$$e ( t ) = Ri ( t ) + L \frac{di ( t )}{dt} + {K}_{e} \frac{dx ( t )}{dt} \qquad Equation 2$$

e(t): voltage [V]
R: resistance [Ω]
L: inductance [H]
Kₑ: back electromotive force constant [V/(m/s)]

Mass m [Kg], displacement x(t) [m], thrust constant Kf [N/A], current i(t) [A], spring constant Kₛₚ [N/m], attenuation coefficient D [N/(m/s)], and the like in actuator 1 can be changed as appropriate within the range that satisfies equation 1. In addition, voltage e(t) [V], resistance R [Ω], inductance L [H], and back electromotive force constant Ke [V/(m/s)] can be changed as appropriate within the range that satisfies equation 2.

As described above, actuator 1 is determined by the mass m of movable body 20 and the spring constant Ksp of the metal springs (elastic bodies, plate springs in the present embodiment) serving as elastic support parts 81 and 82.

### Variations

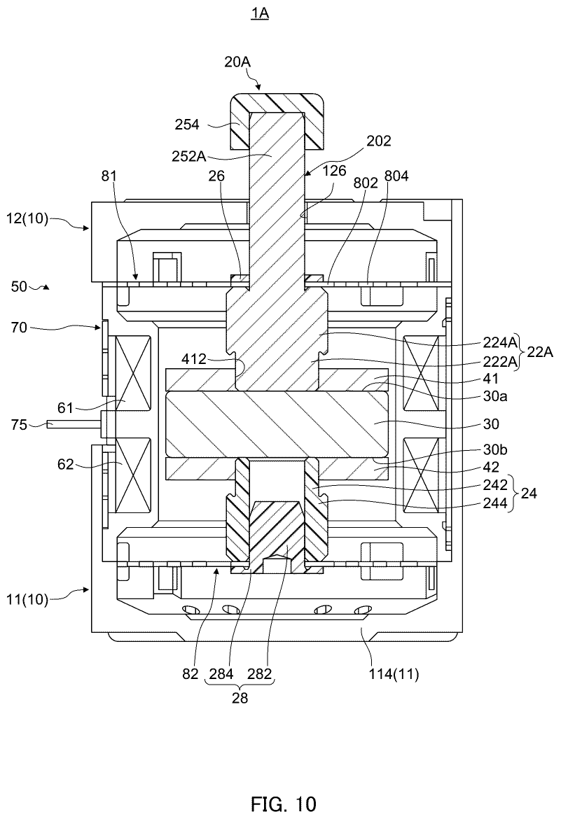

FIGS. 10 to 23 illustrate variations 1 to 7 of actuator 1 of the present embodiment.

Actuators 1A to 1G, which are variations 1 to 7 of actuator 1 illustrated in FIGS. 10 to 23, have the same basic configuration as actuator 1 corresponding to Embodiment 1 illustrated in FIG. 1. Accordingly, in the description of variations 1 to 7, components that are the same as those in Embodiment 1 are indicated by the same symbols and names with duplicate explanations omitted, and for components that are different, the same names and symbols are given for the corresponding components with alphabets are added as appropriate. The operations of actuators 1A to 1G are the same as the operation of actuator 1, and therefore, the explanation for operations of actuators 1A to 1G will be omitted as appropriate. In actuators 1A to 1G, output shaft parts 252, 252C, 252D, and 252F that pass through central openings 126 of the cases move without contacting through central openings 126 of the cases with gaps d1 in between, as movable bodies 20, 20A to 20D, and 20F move.

### Variation 1

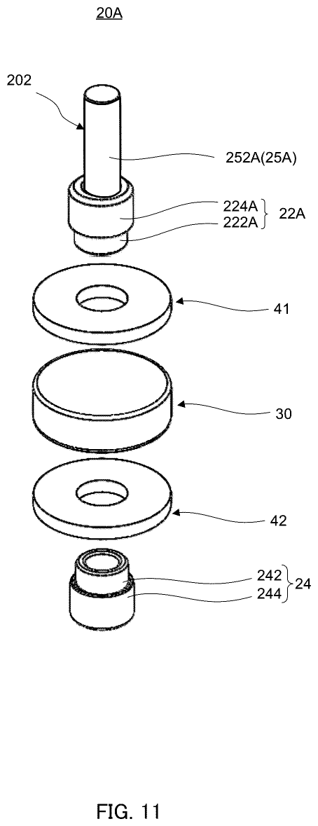

FIG. 10 is a longitudinal cross-sectional view illustrating the main part configuration of variation 1 of the actuator, and FIG. 11 is an enlarged exploded view of a movable body in variation 1.

Actuator 1A, variation 1 of the present embodiment, differs from actuator 1 only in the configuration of movable body 20A, and the other configurations are the same, so the configuration of movable body 20A will be mainly described below.

Movable body 20A of actuator 1A illustrated FIG. 10 differs from movable body 20 of actuator 1 in that output shaft part 252 and first spring retaining part 22 among the components of movable body 20 are integrally formed.

Movable body 20A illustrated in FIGS. 10 and 11 includes shaft unit 202, in addition to magnet 30, yokes 41 and 42, second spring retaining part 24, first spring fixing part 26, and second spring fixing part 28, which have the same configuration as in movable body 20.

Shaft unit 202 is a rod-shaped body, in which first spring retaining part 22A having the same function as first spring retaining part 22 and output shaft part 252A having the same function as output shaft part 252 are integrally formed. Shaft unit 202 is configured such that, from the magnet 30 side, joint part 222A of spring retaining part 22A, spring connection part 224A of spring retaining part 22A, and output shaft part 252A are provided in series on the same axis line in this order. Shaft unit 202 is preferably made of a non-magnetic material, and when shaft unit 202 is made of a non-magnetic material, leakage of magnetic flux in the axial direction via output shaft part 252A can be prevented.

At one end of shaft unit 202, joint part 222A of spring retaining part 22A fits into opening 412 of yoke 41. Together with a press-fit ring (which is first spring fixing part 26), shaft unit 202 connects to and fixes elastic support part 81 at the end surface (on one side) of spring connection part 224A including a stepped surface formed on the outer periphery of output shaft part 252.

As described above, in variation 1, two or more of the components of movable body 20A are integrated, and therefore, it is possible to improve the assembly efficiency. By setting the strength of the parts, spring retaining parts 22 and 24 and output shaft part 252A can be molded with resin, thereby reducing assembly time and manufacturing costs.

### Variation 2

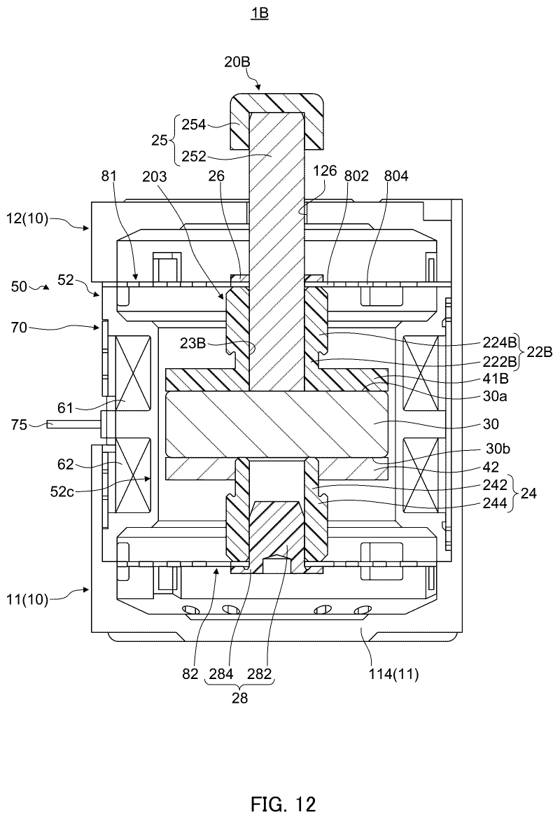

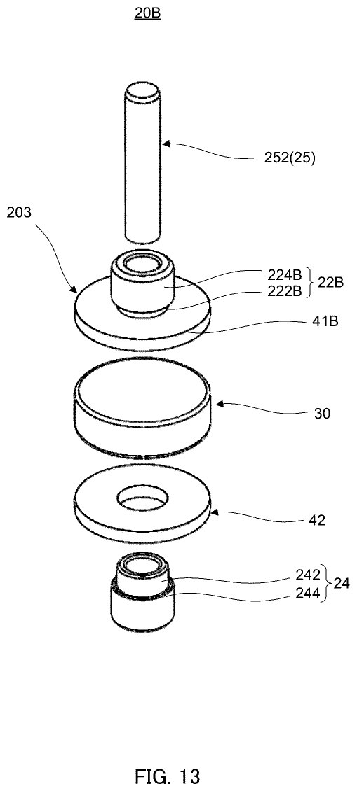

FIG. 12 is a longitudinal cross-sectional view illustrating the main part configuration of variation 2 of the actuator, and FIG. 13 is an enlarged exploded view of a movable body in variation 2.

Actuator 1B, variation 2 of the present embodiment, differs from actuator 1 only in the configuration of movable body 20B, and the other configurations are the same, so the configuration of movable body 20B will be mainly described below.

Movable body 20B of actuator 1B illustrated FIG. 12 differs from movable body 20 of actuator 1 in that yoke 41 and first spring retaining part 22 among the components of movable body 20 are integrally formed.

Movable body 20B illustrated in FIGS. 12 and 13 includes sleeve unit 203, in addition to magnet 30, yoke 42, second spring retaining part 24, first spring fixing part 26, second spring fixing part 28, and output shaft part 252, which have the same configuration as in movable body 20. In sleeve unit 203, yoke 41B having the same function as yoke 41 and first spring retaining part 22B having the same function as first spring retaining part 22 are integrally formed.

Opening 23B (extending through sleeve unit 203 in the axial direction) is formed in the central part of sleeve unit 203 on the axis line. The base end portion of output shaft part 252 is inserted into opening 23B and is fixed. Sleeve unit 203 may be made of a non-magnetic material such as a resin material, or may be made of the same magnetic material as yoke 41. When sleeve unit 203 is a non-magnetic material made of resin, the weights of the front and back surfaces 30a and 30b of magnet 30 may be balanced by making yoke 42 on the back surface 30b side of magnet 30 from a resin material. When sleeve unit 203 is made of a magnetic material, making output shaft part 252 from a non-magnetic material can prevent magnetic flux leakage in the axial direction through output shaft part 252.

Sleeve unit 203 is attached to front surface 30a of magnet 30 so as to stack yoke 41B on the front surface. Output shaft part 252 is inserted into opening 23B inside sleeve unit 203, and the base end side portion of output shaft part 252 is fitted in the opening. Together with first spring fixing part 26 (which is a press-fit ring), sleeve unit 203 connects to and fixes elastic support part 81 at the end surface (on one side) of spring connection part 224B forming a stepped surface on the outer periphery of output shaft part 252.

As described above, in variation 2, two or more of the components of movable body 20B are integrated, and therefore, it is possible to improve the assembly efficiency. By setting the strength of the parts, spring retaining parts 22 and 24 and output shaft part 252 can be molded with resin, thereby reducing assembly time and manufacturing costs.

### Variation 3

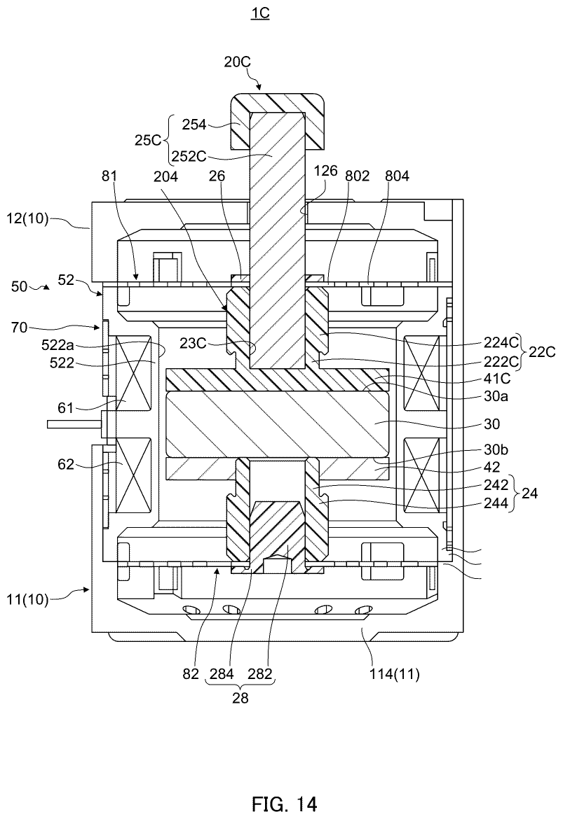

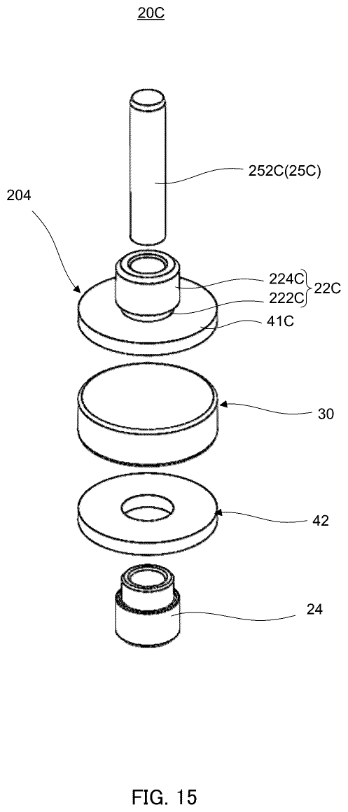

FIG. 14 is a longitudinal cross-sectional view illustrating the main part configuration of variation 3 of the actuator, and FIG. 15 is an enlarged exploded view of a movable body in variation 3.

Actuator 1C, variation 3 of the present embodiment, differs from actuator 1 only in the configuration of movable body 20C, and the other configurations are the same, so the configuration of movable body 20C will be mainly described below.

Movable body 20C of actuator 1C illustrated FIG. 14 differs from movable body 20 of actuator 1 in that portions corresponding to yoke 41 and first spring retaining part 22 among the components of movable body 20 are integrally formed.

Movable body 20C illustrated in FIGS. 14 and 15 includes sleeve unit 204 and protrusion part 25C, in addition to magnet 30, yoke 42, second spring retaining part 24, first spring fixing part 26, and second spring fixing part 28, which have the same configuration as in movable body 20.

In sleeve unit 204, yoke 41C having the same function as yoke 41 and spring retaining part 22C having the same function as spring retaining part 22 are integrally formed. In sleeve unit 204, yoke 41C is a solid member, unlike yoke 41, and is formed, for example, into a disk.

That is, opening 23C at the center of spring retaining part 22C of sleeve unit 204 is formed in a concave shape with the surface portion of yoke 41C as the bottom surface thereof, and output shaft part 252C is inserted into opening 23C. Output shaft part 252C is positioned and fixed on the axis line of movable body 20C by being inserted into opening 23C.

Output shaft part 252C thus does not contact with magnet 30 through sleeve unit 204. Sleeve unit 204 may be made of a non-magnetic material such as a resin material, or may be made of the same magnetic material as yoke 41. When sleeve unit 204 is made of resin, yoke 42 on the back surface 30b side of magnet 30 may also be made of a resin material. When sleeve unit 204 is made of a magnetic material, making output shaft part 252 from a non-magnetic material can prevent magnetic flux leakage in the axial direction through output shaft part 252C.

Sleeve unit 204 is attached to front surface 30a of magnet 30 so as to stack yoke 41C on the front surface. The base end portion of output shaft part 252C is fitted into opening 23C inside sleeve unit 204 while the base end portion is in contact with the bottom surface of opening 23C. In addition, together with first spring fixing part 26, sleeve unit 204 connects to and fixes the inner peripheral surface of elastic support part 81 at the end surface (on one side) of spring connection part 224C including a stepped surface formed on the outer periphery of output shaft part 252C.

As described above, in variation 3, two or more of the components of movable body 20C are integrated, and therefore, it is possible to improve the assembly efficiency. By setting the strength of the parts, spring retaining part 24 and output shaft part 252 can be molded with resin, thereby reducing assembly time and manufacturing costs.

### Variation 4

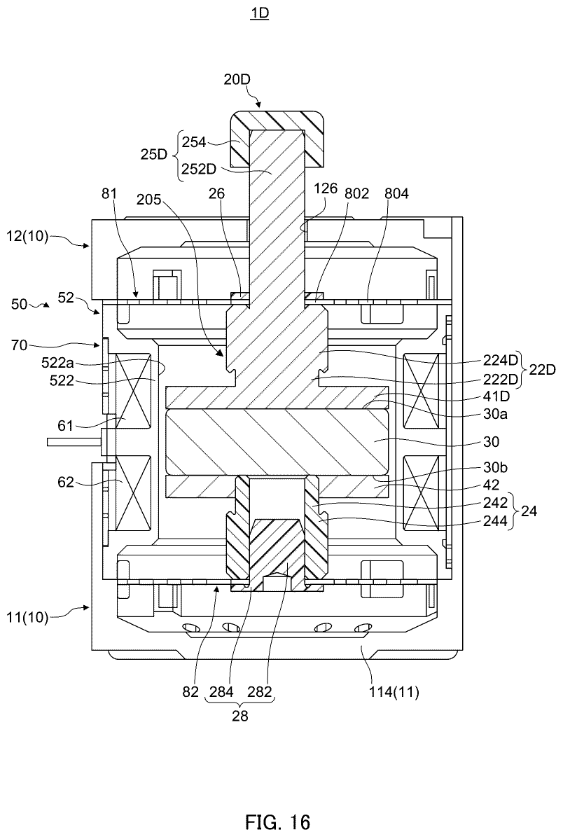

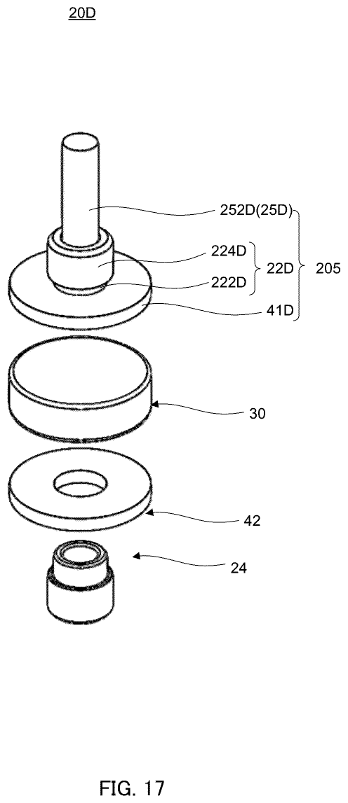

FIG. 16 is a longitudinal cross-sectional view illustrating the main part configuration of variation 4 of the actuator, and FIG. 17 is an enlarged exploded view of a movable body in variation 4.

Actuator 1D, variation 4 of the present embodiment, differs from actuator 1 only in the configuration of movable body 20D, and the other configurations are the same, so the configuration of movable body 20D will be mainly described below.

Movable body 20D of actuator 1D illustrated FIG. 16 differs from movable body 20 of actuator 1 in that portions corresponding to yoke 41, first spring retaining part 22, and output shaft part 252 among the components of movable body 20 are integrally formed.

Movable body 20D illustrated in FIGS. 16 and 17 includes shaft unit 205, in addition to magnet 30, yoke 42, second spring retaining part 24, first spring fixing part 26, and second spring fixing part 28, which have the same configuration as in movable body 20.

In shaft unit 205, yoke 41D having the same function as yoke 41, spring retaining part 22D having the same function as spring retaining part 22, and output shaft part 252D having the same function as output shaft part 252 are integrally formed. In shaft unit 205, yoke 41D is a solid member, unlike yoke 41, and is formed, for example, into a disk.

That is, in shaft unit 205, joint part 222D and spring connection part 224D of spring retaining part 22D and output shaft part 252 are provided in series in one direction (upward) on the axis line of movable body 20D, on the central part of yoke 41D.

Simply attaching shaft unit 205 to front surface 30a of magnet 30 can assemble the yoke, the spring retaining part, and the output shaft part at once. Shaft unit 205 may be made of a non-magnetic material such as a resin material, or may be made of the same magnetic material as yoke 41.

Shaft unit 205 is attached to front surface 30a of magnet 30 so as to stack yoke 41D on the front surface. In addition, together with first spring fixing part 26, shaft unit 205 connects to and fixes the inner peripheral surface of elastic support part 81 at the end surface (on one side) of spring connection part 224D including a stepped surface formed on the outer periphery of output shaft part 252D.

As described above, in variation 4, two or more of the components of movable body 20D are integrated. Specifically, the three members are produced as one integral part as shaft unit 205, thereby improving the assembly efficiency and achieving high rigidity of shaft unit 205 itself.

### Variation 5

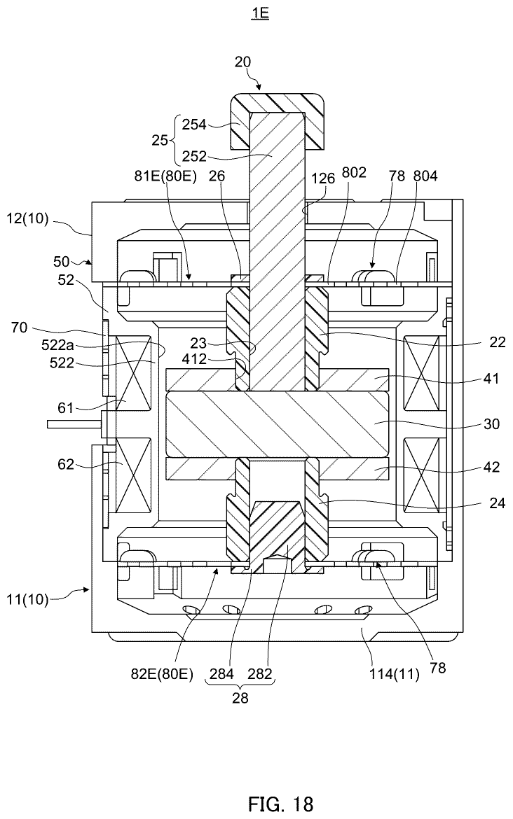

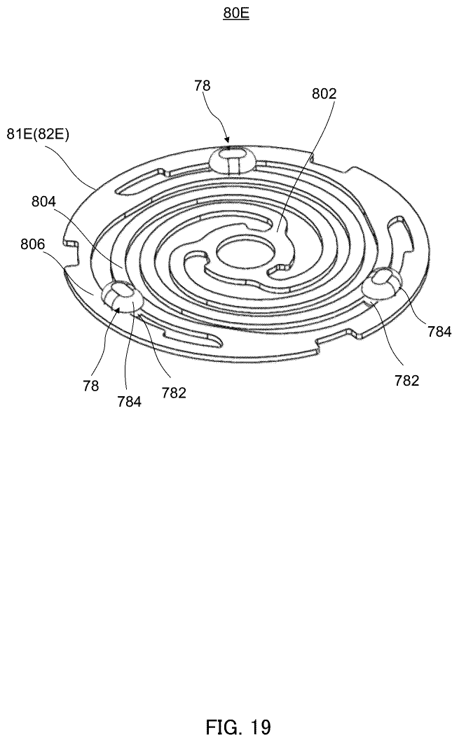

FIG. 18 is a longitudinal cross-sectional view illustrating the main part configuration of variation 5 of the actuator, and FIG. 19 is a perspective view of a leaf spring in variation 5.

Actuator 1E, variation 5 of the present embodiment, differs from actuator 1 only in the configuration of elastic support parts 81 and 82, and the other configurations are the same.

Actuator 1E illustrated in FIG. 18 has a structure similar to that of actuator 1 except that attenuation parts 78 are provided on elastic support parts 81 and 82.

As illustrated in FIG. 19, for example, a portion of attenuation part 78 is inserted between the spring portions (specifically, between outer peripheral fixed part 806 and deformable arm part 804) from one side of elastic support part 81E or 82E, thereby disposing the attenuation part so as to bridge the spring portions.

Attenuation part 78 includes elastic deformable push-in part 782 and flange 784 formed continuously with elastic deformable push-in part 782.

When elastic push-in part 782 is inserted between the spring portions from one side of elastic support part 81 (82), specifically between outer peripheral fixed part 806 and deformable arm part 804, flange 784 of attenuation part 78 is positioned to bridge the spring portions.

Push-in part 784 may be fixed on the back side of elastic support part 81E (82E) in a shape that prevents push-in part 782 from coming off from between the spring portions, by using a thermosetting resin (not illustrated) or an adhesive that does not adhere to elastic support part 81E (82E). Attenuation part 78 does not need to be an elastomer as long as attenuation part 78 is made of a material that has an attenuation function, and may be made of a thermosetting resin, an adhesive, or the like.

Attenuation part 78 may have any configuration as long as attenuation part 78 has a shape in which elastic support part 81 (82) is held from both sides between a plate-shaped flange and a separate member joined at the push-in part and having the same function as the flange.

With this configuration, attenuation part 78 attenuates the sharp spring resonance in elastic support part 81E (82E), and prevents the difference in vibration depending on the frequency from becoming large due to a significant increase in vibration near the resonance frequency. As a result, movable body 20 can suppress resonance peaks before being plastically deformed, and generate stable vibration over a wide range without contacting lid part 12 and bottom part 114. Therefore, no abnormal noise is generated due to contact. Attenuation part 78 may be formed in any shape, from any material, and the like as long as attenuation part 78 prevents sharp vibrations from occurring in elastic support part 81 (82).

### Variation 6

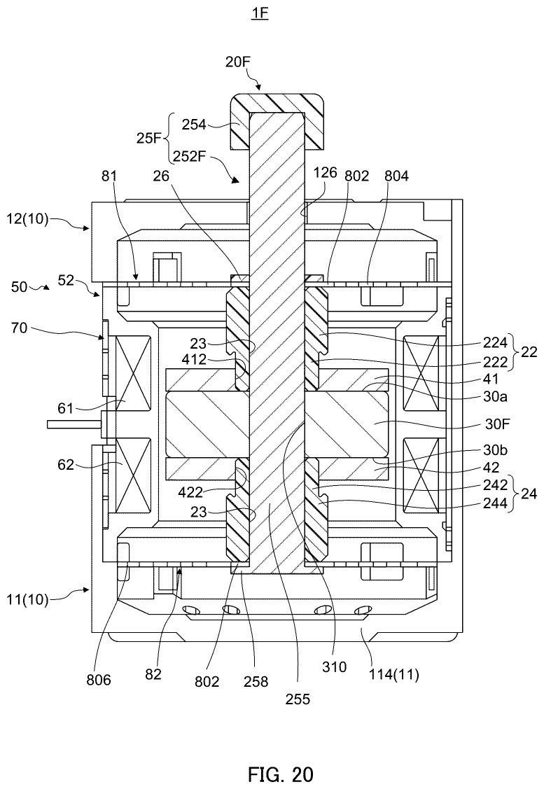

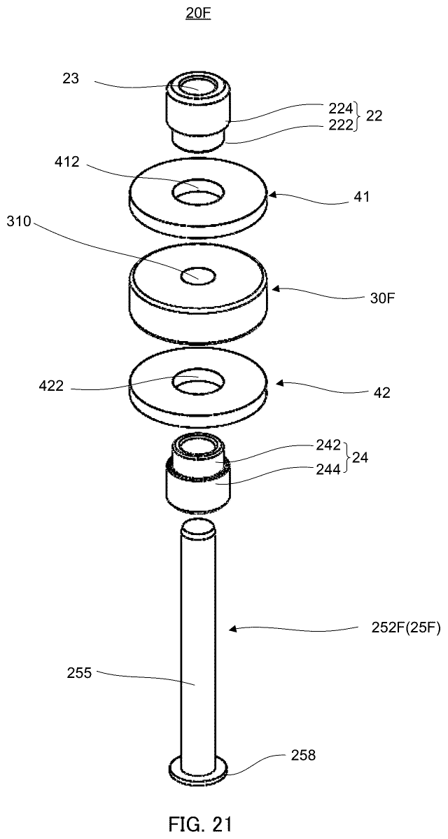

FIG. 20 is a longitudinal cross-sectional view illustrating the main part configuration of variation 6 of the actuator, and FIG. 21 is an enlarged exploded view of a movable body in variation 6.

Actuator 1F, variation 6 of the present embodiment, differs from actuator 1 only in the configuration of movable body 20F, and the other configurations are the same, so the configuration of movable body 20F will be mainly described below.

Movable body 20F of actuator 1F illustrated FIG. 20 differs from movable body 20 of actuator 1 in that output shaft part 252F passes through magnet 30F, yokes 41 and 42, first spring retaining part 22, and second spring retaining part 24.

Movable body 20F illustrated in FIGS. 20 and 21 includes output shaft part 252F (protrusion part 25F) and magnet 30F, in addition to yokes 41 and 42, first spring retaining part 22, second spring retaining part 24, first spring fixing part 26, and second spring fixing part 28, which have the same configuration as in movable body 20.

Movable body 20F includes magnet 30F with an opening extending through magnet 30F at the center of magnet 30F. Yokes 41 and 42 having the same outer diameter as magnet 30F are respectively disposed on the front and back surfaces 30a and 30b of magnet 30F.

Opening 310 of magnet 30F has an inner diameter that allows the insertion of output shaft part 252F. The inner diameter of opening 310 of magnet 30F is approximately the same as the outer diameter of output shaft part 252F, and smaller than the inner diameter of yoke 41.

Joint parts 222 and 242 (which are one ends of spring retaining parts 22 and 24) are respectively inserted into and fixed to the openings of yokes 41 and 42 on both sides of magnet 30F.

Output shaft part 252F is a shaft with a flange, and has the functions of second spring fixing part 26 and output shaft part 252.

Output shaft part 252F includes a cylindrical shaft part 255 and flange part 258 integrally formed on the base end side of shaft part 255.

Output shaft part 252F extends from one end to the other end of the movable body.

Output shaft part 252F holds inner peripheral part 802 of elastic support part 82 between flange part 258 and the annular end surface of spring connection part 244 of second spring retaining part 24.

In a state in which shaft part 255 pierces elastic support part 82, second spring retaining part 24, yoke 42, magnet 30F, yoke 41, first spring retaining part 22, elastic support part 81, and first spring fixing part 26, output shaft part 252F integrally fix these parts by holding these parts between flange part 258 and first spring fixing part 26.

That is, output shaft part 252F is disposed so as to pass through movable body 20F on the axis of movable body 20F, and therefore, other members can be assembled without movable body 20F as the axis shifting. Output shaft part 252F may be formed of a non-magnetic material such as a resin material, or may be formed of the same magnetic material as yoke 41. In addition, it is preferred that at least one of elastic support part 82, second spring retaining part 24, yoke 42, magnet 30F, yoke 41, first spring retaining part 22, and elastic support part 81 is fixed to shaft part 255 by, for example, press-fitting, welding, or adhesion.

With this configuration and during the formation of movable body 20F, magnet 30F, yokes 41, 42, and spring retaining part 22, 24 allow output shaft part 252F (which is a flanged shaft) to pass therethrough, and are fixed with first spring fixing part 26 (which is a press-fit ring). In addition, output shaft part 252F can also reliably and stably connect elastic support parts 81 and 82 to movable body 20F. Therefore, it is possible to produce a structurally stable movable body by fixing the members without relying only on adhesion.

### Variation 7

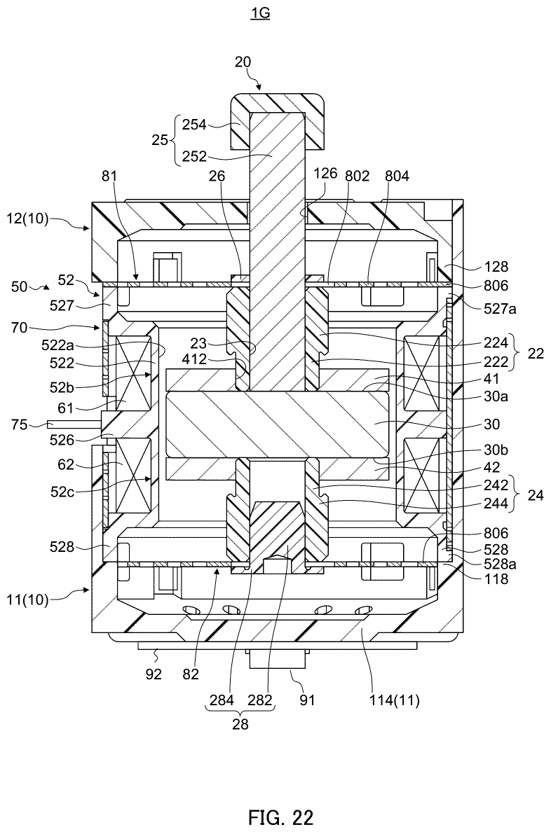

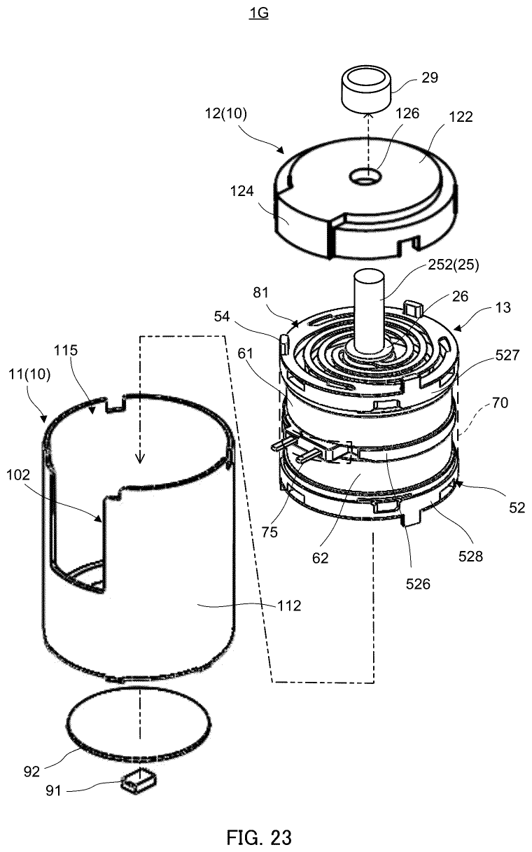

FIG. 22 is a longitudinal cross-sectional view illustrating the main part configuration of variation 7 of the actuator, and FIG. 23 is an exploded view illustrating the internal configuration of variation 7 of the actuator with the case thereof removed.

Actuator 1G, variation 7 of the present embodiment, differs from actuator 1 in that actuator 1G includes magnetic sensor 91, and the other configurations are the same. Accordingly, different configurations will be described in detail, and explanations for the same configurations as actuator 1 will be omitted.

Actuator 1G houses movable body 20 in a hollow case 10 in such a way that movable body 20 can reciprocate between upper and lower end surfaces with the axial direction (vertical direction) of case 10 as the moving direction. Actuator 1G includes magnetic sensor 91 that detects the moving position of movable body 20.

Actuator 1G transmits the movement of the movable body to the stimulation subject via output shaft part 252 provided on movable body 20, thereby applying a stimulus.

Magnetic sensor 91 is provided apart from movable body 20 in the moving direction of movable body 20.

Magnetic sensor 91 is mounted on circuit board 92 and detects a change in magnetic flux due to movement of magnet 30 of movable body 20, and detects the position change of movable body 20.

Magnetic sensor 91 is separated from movable body 20 in the movement (reciprocating movement) direction of movable body 20 and is disposed at a position facing the movable body. Magnetic sensor 91 may be provided in any form on movable body 20 or fixed body 50. The moving direction of movable body 20 may be, for example, the opposite direction to the direction in which movable body 20 moves. That is, the position of magnetic sensor 91 may be in the same direction or in a different direction as long as the magnetic sensor faces in the same direction as the moving direction of movable body 20.

Magnetic sensor 91 is preferably provided on the central axis extending in the reciprocating direction of movable body 20 (at a position superimposed on the axis of output shaft part 252), or provided in the vicinity of the central axis.

Magnetic sensor 91 is attached to the bottom surface of case main body 11 together with circuit board 92, and magnetic sensor 91 is located on the axis line of output shaft part 252 of movable body 20.

Magnetic sensor 91 is provided on the outer surface of case 10, and therefore, the magnetic sensor can be assembled outside actuator 1 to improve the assembly efficiency of actuator 1.

In addition, magnetic sensor 91 can be easily retrofitted or replaced without disassembling actuator 1. Magnetic sensor 91 in actuator 1 can be easily inspected.

Magnetic sensor 91 is preferably a Hall sensor with a built-in amplifier, such as a linear Hall IC, whose output voltage range is defined by a power supply, and which amplifies the output of a Hall element with an amplifier and linearly outputs the output.

As a result, the peripheral circuit can be configured easily and inexpensively without using a separate sensor, amplifier, or converter such as a dedicated AD converter. For example, the magnetic sensor is preferably such that the circuit configuration of the subsequent stage of is easier than when simply using a Hall element, and it may be a Hall IC that compares the output of the Hall element with a predetermined threshold value and outputs High/Low values. Even when a Hall IC is used, the output voltage range is defined by a power supply, making it easier to create the subsequent circuit (microcomputer).

### Circuit Board (Control Part) 92

Circuit board 92 is equipped with a microcomputer, an actuator driver, and the like in addition to magnetic sensor 91, and includes control part that controls the actuator.

In circuit board 92, magnetic sensor 91 detects the load applied to movable body 20 via output shaft part 252, and coils 61 and 62 are energized according to the detection result to control the movement of movable body 20. The control part does not have to be provided in actuator 1.

Actuator 1 thus can detect the load and apply a stimulus corresponding to the detection result.

By using magnetic sensor 91, magnet 30 (which is necessary as an actuator) is used as a sensor, so that an inexpensive movable body position detection means can be provided.

The lower surface of the case on which magnetic sensor 91 is provided is made of a non-magnetic material as case 10 is made of a non-magnetic material. With this configuration, magnetic sensor 91 can detect stable magnetic flux density in a magnetic circuit including magnet 30, and can accurately detect the position of movable body 20.

In addition, the magnetization direction of magnet 30 is parallel to the moving direction of movable body 20, and therefore, magnetic sensor 91 detects the magnetic flux density of the distribution of a single magnetic pole, which improves sensor detectability and achieves a stable sensor output.

Movable body 20 is housed inside the annular coils 61 and 62 so as to be able to be driven in the axial direction. This configuration can form a magnetic circuit that can generate thrust more efficiently. In addition, in this magnetic circuit, the flow of magnetic flux outward in the radial direction of magnet 30 is regulated by outer yoke 70, thereby increasing the magnetic flux density toward the bottom part 114 side. Detection by magnetic sensor 91 disposed on the bottom part 114 thus can be performed accurately and easily.

Magnetic sensor 91 detects the position of movable body 20, 20A to 20D, or 20F that is pushed in by detecting the intensity of the magnetic flux (detected magnetic flux) flowing toward the bottom part 114 side. In addition, magnetic sensor 91 detects the intensity of the detected magnetic flux on the time axis, and the velocity at which the movable body is pushed in can be determined based on the change. The control part can also detect the amount of push-in from the spring reaction force and determines that the detected position is a position at which a pushing force can be exerted based on the relationship between the pushing force and the spring reaction force relative to the elastic deformation of elastic support parts 81 and 82 when the movable body is pushed in. Accordingly, actuator 1G including magnetic sensor 91 is used as an actuator that has a position and load detection function and can provide feedback based on information on position and velocity, information on load of movable part, push-in load, and the like.

In addition, as an actuator for a stimulus applying device, even when there are variations in product performance due to component dimensional tolerances or assembly variations, force feedback can be performed based on the load, and therefore, a uniform stimulus can be applied to different products.

That is, according to actuator 1G, when movable body 20 moves, magnet 30 moves, so the distribution of magnetic flux changes, and by detecting the amount, the position and velocity of the movable part can be detected. In addition, by controlling the current based on the position and velocity information, the movement of movable body 20 can be controlled, thereby achieving excellent tactile sensation expression and tactile variation suppression.

### Configuration of Stimulus Applying Device 900

Hereinafter, the configuration of stimulus applying device 900 according to the present embodiment will be described.

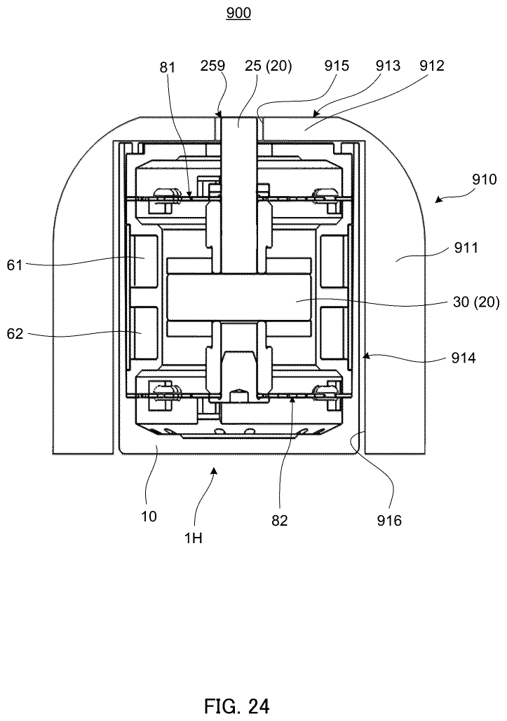

As illustrated in FIG. 24, stimulus applying device 900 includes actuator 1H and housing 910. Actuator 1H may be any one of the actuators 1, 1A, 1B, 1C, 1D, 1E, 1F, and 1G described above; however, for convenience of explanation, the internal configuration of actuator 1 will be described as an example of the internal configuration of actuator 1H. Case 10 of actuator 1H is an example of a fixed body with a configuration such that the head part of protrusion part 25 is disposed outside the fixed body, and the movable main body (including at least magnet 30) of movable body 20 is housed inside the fixed body.

Housing 910 includes a tubular housing body part 911 and housing top part 912 that covers the upper surface of housing body part 911. Housing top part 912 includes flat main surface 913 on the upper side thereof, and housing body part 911 includes housing cavity 914 in which actuator 1H can be disposed. Housing body part 911 houses actuator 1H in housing cavity 914 with protrusion part 25 of actuator 1H inserted into housing upper opening 915 formed in the central part of housing top part 912. The bottom part of housing body part 911 is open downward, and therefore, actuator 1H can be inserted into housing cavity 914 through lower opening 916 of the housing (also referred to as “housing lower opening 916”) for assembling stimulus applying device 900.

Flat main surface 913 of housing top part 912 includes an opening (housing upper opening 915) that surrounds the head part of protrusion part 25 (hereinafter simply referred to as the “protrusion head”). Flat main surface 913 is an example of a main surface that extends around the protrusion head in directions intersecting the movement direction (direction of vertical movement of movable body 20). In the present embodiment, flat main surface 913 is a surface perpendicular to the movement direction. During the use of stimulus applying device 900, the surface of a subject (for example, a body) (hereinafter referred to as “subject surface”) contacts with flat main surface 913.

Actuator 1H is fastened to the housing 910 by, for example, a fastening member. Accordingly, case 10 of actuator 1H is immovably positioned in housing cavity 914.

In actuator 1H, coils 61 and 62 and magnet 30 form an electromagnetic driving part, a movable main body (including magnet 30) is reciprocating in the movement direction along the protruding direction of protrusion part 25 by electromagnetic drive caused by the cooperation of the energized coils 61 and 62 and magnet 30. With this movement, the protrusion head is caused to protrude and retract from flat main surface 913 of housing 910. The protrusion head locally pokes the subject surface whose position is regulated by contacting with flat main surface 913, and as a result, a stimulus is locally applied to the subject surface.

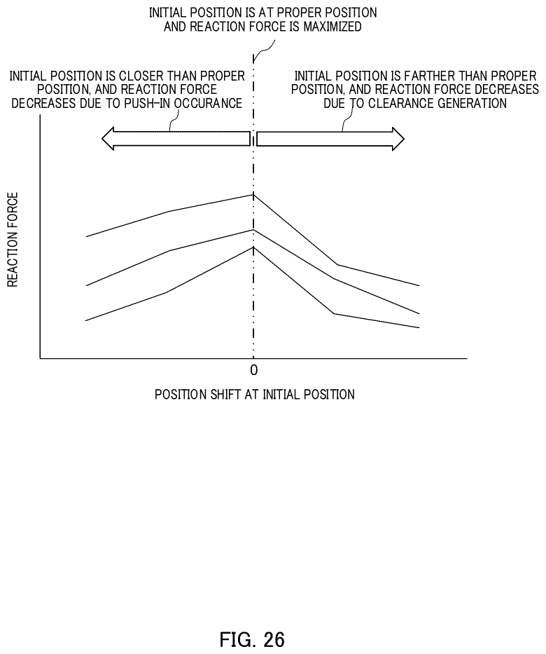

Here, the following case will be considered: the positional relationship between the subject surface and the protruding tip is not in a proper position during use. The proper position is the position of the protrusion head when the movable main body is at the center of vibration. At the proper position, when the movable main body moves, the speed of movement of the movable main body is maximized, and the reaction force that can act as a stimulus on the contact target of the protrusion head is maximized (see FIG. 26).

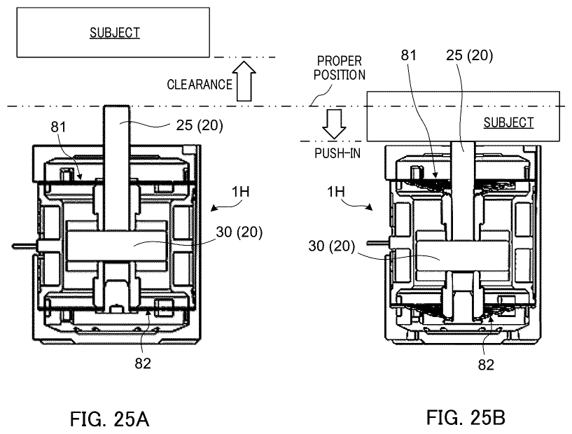

For example, as illustrated in FIG. 25A, when the initial position of the subject surface (here, “initial” means immediately before movement of movable main body (non-moving period)) is farther than the proper position is, the clearance is generated between the subject surface and the protrusion head. The protrusion head comes into contact with the subject surface when the protrusion head is moved above the proper position; however, but the protrusion head moving upward at a position above the proper position is in the process of deceleration, and therefore, the reaction force that acts as a stimulus on the subject surface decreases (see FIG. 26).

For example, as illustrated in FIG. 25B, when the initial position of the subject surface is closer than the proper position is, a phenomenon in which the protrusion head is pushed into the subject surface (push-in) occurs. The protrusion head comes into contact with the subject surface at a position lower than the proper position; however, the protrusion head moving upward cannot be accelerated at a position lower than the proper position, and therefore, the reaction force that acts as a stimulus on the subject surface decreases (see FIG. 26).

Regarding this problem, in stimulus applying device 900 according to the present embodiment, flat main surface 913 of housing 910 contacts with the subject surface to regulate the position of the subject surface in the movement direction. Therefore, simply by disposing flat main surface 913 at a position where the reaction force satisfies a desired level, it becomes possible to efficiently transmit the stimulating movement to the subject. In addition, the transmission of the movement becomes efficient, and therefore, there is no need to increase the size of the movable body and thus the size of actuator 1H, in order to increase the reaction force.

In particular, in the present embodiment, the position of housing upper opening 915 of flat main surface 913 in the movement direction coincides with the initial position of the protrusion head in the movement direction. Therefore, neither clearance nor push-in as described above occurs, so that the reaction force that acts as a stimulus on the subject surface can be maximized, and the stimulus can be applied with maximum efficiency.

### Configuration of Wearable Device 950

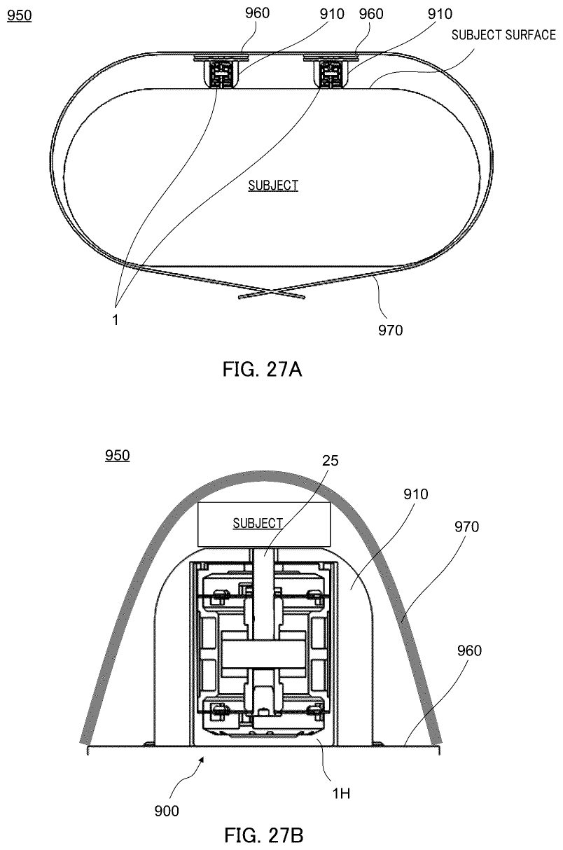

FIG. 27A schematically illustrates the overall configuration of wearable device 950 including stimulus applying device 900, and FIG. 27B schematically illustrates a fixed state of housing 910 in wearable device 950.

Wearable device 950 includes stimulus applying device 900, base part 960, and belt 970. As illustrated in FIG. 27A, wearable device 950 may include a plurality of stimulus applying devices 900.

As illustrated in FIG. 27B, housing 910 of stimulus applying device 900 is fixed to base part 960 while the fixed body of actuator 1H is immovably positioned. Housing 910 is fixed to base part 960 by, for example, a fastening member.

By fixing the housing 910 in this way, the subject surface can be reliably maintained in a proper position where neither clearance (see FIG. 25A) nor pushing (see FIG. 25B) occurs, and therefore, the efficiency of stimulus application can be maintained.

Stimulus applying device 900 is attached to belt 970 via base part 960. Base part 960 is fixed to belt 970 by, for example, a fastening member.

Belt 970 is an example of a holding part that is connected to base part 960 and holds a subject in such a way that the subject surface is in contact with flat main surface 913. In the present embodiment, the holding part is belt 970, and thus wrapping belt 970 around the outer periphery of a subject can hold the subject and bring the subject surface into contact with flat main surface 913. The subject surface thus can be reliably disposed at the proper position.

When belt 970 is tightly wrapped around a subject, flat main surface 913 of housing 910 is subjected to strong pressure from the subject surface. At this time, when housing 910 and base part 960 bend due to the pressure, the reaction force will be absorbed, resulting in a problem that the efficiency of stimulus application will be reduced. Accordingly, both housing 910 and base part 960 preferably have a rigidity such that housing 910 and base part 960 do not deform due to pressure from the subject surface applied to flat main surface 913.

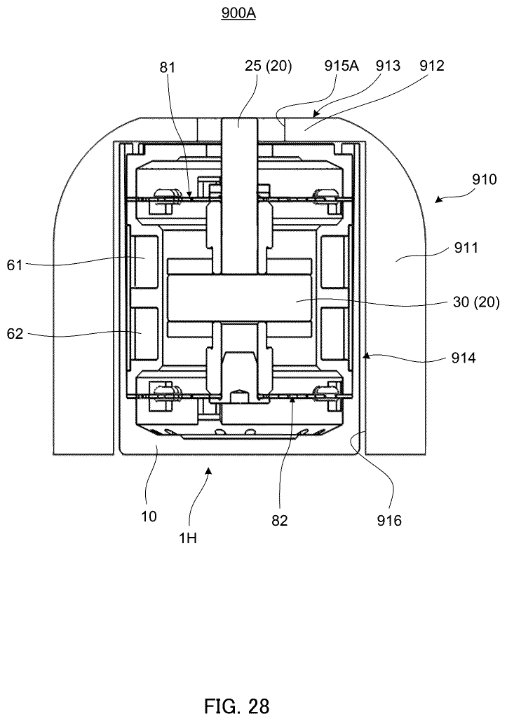

In addition, as stimulus applying device 900A illustrated as a comparative example in FIG. 28, when a stimulus applying device has the configuration in which housing upper opening 915A is wide, a gap is created in the vicinity of protrusion part 25, and depending on the softness of the subject, the subject surface may enter the gap. In such a case, the protrusion head may be slightly pushed in by the subject surface, resulting in a decrease in reaction force. Accordingly, in stimulus applying device 900, housing upper opening 915 is preferably set to have a size that leaves almost no gap in the vicinity of protrusion part 25.

Further, the shape of the protrusion head of protrusion part 25 is preferably cylindrical (the upper end surface of the protrusion head is flat and circular when viewed from the direction in which a stimulus is applied to a subject). The reason therefore is as follows: effective stimulus can be applied to a subject by forming the protrusion head of protruding part 25 into a cylindrical shape, even when the direction in which a stimulus is applied from protrusion part 25 to a subject surface is slightly tilted from the vertical position, a portion of the circumferential corner part 259 of the protrusion head would come into contact with the subject before any other components comes into contact, thereby applying the stimulus. Therefore, it is possible to increase the intensity of stimulus application and provide effective stimulus application to the subject.

The holding part does not need to be in the form of belt 970, and when the subject is, for example, a person, the holding part may be a vest or other type of clothing that can be worn by the person. In addition, when stimulus applying device 900 is used as a non-wearable device, the holding part does not need to be in the form of a belt or clothing.

### Variation 1 of Stimulus Applying Device

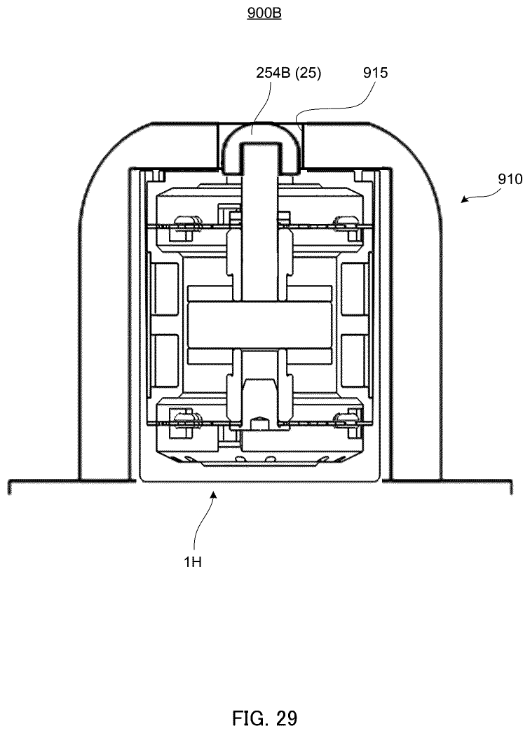

FIG. 29 is a longitudinal cross-sectional view illustrating the configuration of stimulus applying device 900B according to variation 1. In variation 1, the protrusion head has a dome shape whose end surface is spherical. In this case, the position of housing upper opening 915 of flat main surface 913 coincides with the position of the apex of the spherical surface. With this configuration, efficient stimulus application can be achieved with the subject surface in a proper position without any clearance or push-in, even when the protrusion head is spherical.

### Variation 2 of Stimulus Applying Device

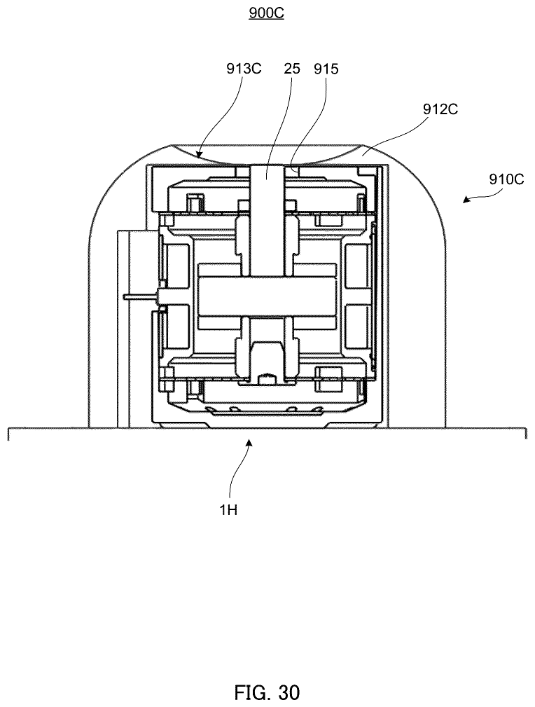

FIG. 30 is a longitudinal cross-sectional view illustrating the configuration of stimulus applying device 900C according to variation 2. In variation 2, the upper surface of housing top part 912C is recessed main surface 913C that is recessed downward at the central part thereof. In this configuration, the position of housing upper opening 915 in the recessed central part of recessed main surface 913C coincides with the initial position of the protrusion head. Accordingly, the subject surface contacts with the protrusion head at a proper position, and therefore, efficient stimulus application can be achieved without reducing reaction force.

Furthermore, in this configuration, the subject enters the concave portion of recessed main surface 913C while being deformed along the curvature of recessed main surface 913C. Therefore, the subject surface is more likely to contact the protrusion head while the subject surface is inclined (hereinafter simply referred to as the “inclined state”) with respect to a plane perpendicular to the protruding direction. The slightly sharp outer peripheral part of the protrusion head thus can be brought into contact with the subject surface. In addition, the contact resistance with recessed main surface 913C in the surrounding portion of the part to be brought in contact with the protrusion head is reduced compared to the case of flat main surface 913, and therefore, the position of a part contacting with the protrusion head is more likely to change when the part is poked by the protrusion head. For these reasons, in variation 2, the intensity of stimulus application can be increased.

In variation 2, recessed main surface 913C is an example of an inclination generating part that causes a subject surface to be in an inclined state when the subject surface is in contact with the protrusion head.

### Variation 3 of Stimulus Applying Device

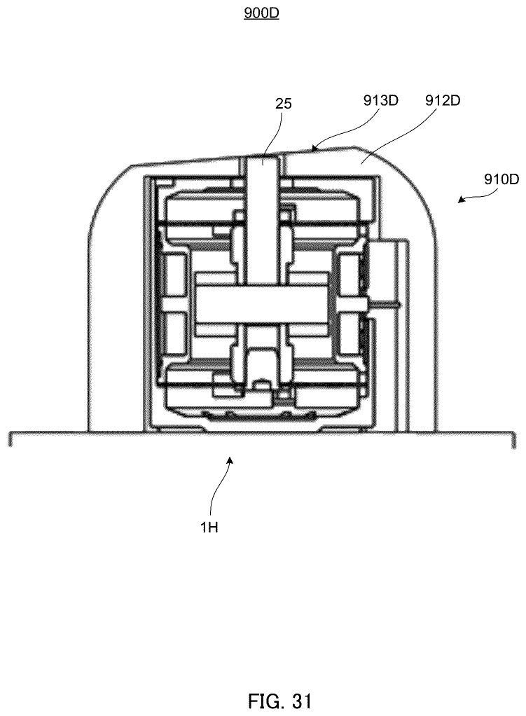

FIG. 31 is a longitudinal cross-sectional view illustrating the configuration of stimulus applying device 900D according to variation 3. In variation 3, the upper surface of housing top part 912D is inclined main surface 913D that is flat but inclined at a predetermined angle. In this configuration, also the position of housing upper opening 915 in the central part of inclined main surface 913D coincides with the initial position of the protrusion head. Accordingly, the subject surface contacts with the protrusion head at a proper position, and therefore, efficient stimulus application can be achieved without reducing reaction force.

Furthermore, in this configuration, when a subject is brought into contact with inclined main surface 913D, the subject surface becomes inclined along the inclined main surface 913D, and therefore, the subject surface inevitably contacts with the protrusion head in an inclined state. The slightly sharp outer peripheral part of the protrusion head thus can be brought into contact with the subject surface, and therefore, the intensity of stimulus application can be increased.

In variation 3, inclined main surface 913D is an example of an inclination generating part that causes a subject surface to be in an inclined state when the subject surface is in contact with the protrusion head.

The embodiments of the present invention have been described above. The above description is an illustration of preferred embodiments of the invention, and the scope of the invention is not limited thereto. That is, the descriptions of the configurations of the devices and the shapes of parts are merely examples, and it is clear that various changes and additions can be made to these examples within the scope of the present invention.

### INDUSTRIAL APPLICABILITY

The stimulus applying devices according to the present invention have effect of efficiently transmitting a movement serving as a stimulus to a subject to be stimulated while an increase in device size is limited and are particularly advantageous as wearable devices.

### REFERENCE SIGNS LIST

1, 1A, 1B, 1C, 1D, 1E, IF, 1G, 1H Actuator
10, 10A, 10B, 10C, 10D Case
11 Case main body
12 Lid part
13 Unit
20, 20A, 20B, 20C, 20D, 20F Movable body
20a Outer peripheral surface
22, 22A, 22B, 22C, 22D First spring retaining part
23, 23B, 23C Opening
24, 24A, 24B, 24C, 24D Second spring retaining part
25, 25A, 25B, 25C, 25D, 25F Protrusion part
26 First spring fixing part
28 Second spring fixing part
30, 30F Magnet
30a Front surface
30b Back surface
41, 41B, 41C, 41D, 42 York
50 Fixed body
52 Coil holding part
52b Coil attachment part
52c Coil attachment part
54 Movable range forming part
61.62 Coil
70 Outer yoke
75 Terminal part
78 Attenuation part
81, 81E, 82E, 82 Elastic support part (plate spring)
91 Magnetic sensor
92 Circuit board (control part)
102 Notch part
112 Peripheral wall part
114 Bottom part
115, 310, 412, 422 Opening
118 Stepped part
122 Top surface part
124 Projection part
126 Central opening
128 Pressing part
202, 205 Shaft unit
203, 204 Sleeve unit
222, 222A, 222D, 242 Joint part
224, 224A, 224B, 224C, 224D, 244, 244A Connection part
252, 252A, 252B, 252C, 252D, 252F Output shaft part
254, 254B Cap
255 Shaft part
258 Flange part
259 Corner part
282 Insertion part
284 Flange
522 Holding part main body
522a Inner peripheral surface
526 Central flange part
527 Flange part
527a, 528a End surface
528 Flange part
782 Elastic push-in part
784 Flange
802 Inner peripheral part
804 Deformable arm part
806 Outer peripheral fixed part
900, 900A, 900B, 900C, 900D Stimulus applying device
910, 910A, 910C, 910D Housing
911 Housing body part
912, 912C, 912D Housing top part
913 Flat main surface
913C Recessed main surface
913D Inclined main surface
5 914 Housing cavity
915, 915A Housing upper opening
916 Housing lower opening
950 Wearable device
960 Base part
970 Belt

1. A stimulus applying device, comprising:
an actuator and a housing, wherein
the actuator includes
a movable main body, a protrusion part that protrudes from the movable main body and includes a head part configured to locally contact with a surface of a subject during use of the stimulus applying device, and a fixed body with a configuration such that the head part is disposed outside the fixed body, and the movable main body is housed inside the fixed body, and
the actuator generates
a movement of the movable main body in a movement direction along a protruding direction of the protrusion part by electromagnetic drive and locally applies a stimulus to the surface by the movement, and
the housing includes a main surface that extends around the head part in a direction intersecting the movement direction, and the housing allows the main surface to contact with the surface during the use to regulate a position of the surface in the movement direction.

2. The stimulus applying device according to claim 1, wherein:
the main surface includes an opening surrounding the head part; and
a position of the opening in the movement direction coincides with a position of the head part in the movement direction when the movable main body is not moving.

3. The stimulus applying device according to claim 2, wherein:
the head part has a cylindrical shape with an end surface of the head part being a flat surface or has a dome shape with the end surface being a spherical surface; and
the position of the opening in the movement direction coincides with a position of the flat surface or an apex of the spherical surface in the movement direction when the movable main body is not moving.

4. The stimulus applying device according to claim 1, further comprising:
an inclination generating part that causes the surface to be inclined with respect to a plane perpendicular to the protruding direction when the surface is in contact with the head part.

5. The stimulus applying device according to claim 1, wherein
the housing is fixed to a base part while the fixed body is immovably positioned.

6. The stimulus applying device according to claim 5, further comprising:
the base part; and
a holding part that is connected to the base part and holds the subject in such a way that the surface is in contact with the main surface.

7. The stimulus applying device according to claim 6, wherein
the housing and the base part have a rigidity such that the housing and the base part do not deform due to pressure applied from the surface to the main surface when the subject is held by the holding part.

8. A wearable device, comprising:
the stimulus applying device according to claim 6, wherein
the holding part is a belt or clothing that is configured to be attached to the subject during the use.
